(19) United States
(12) Patent Application Publication
(10) Pub. No.: US 2013/0303700 A1
(43) Pub. Date: Nov. 14, 2013

(54) BLENDS OF PARTIALLY HYDROGENATED NITRILE RUBBER AND SILICONE RUBBER, VULCANIZABLE MIXTURES AND VULCANIZATES BASED THEREON

(71) Applicants: Werner Obrecht, Moers (DE); Kevin Kulbaba, Leverkusen (DE); Julia Maria Muller, Koln (DE); Matthias Soddemann, Schattdorf (CH); Oskar Nuyken, Munchen (DE); Carola Gantner, Memmingen (DE)

(72) Inventors: Werner Obrecht, Moers (DE); Kevin Kulbaba, Leverkusen (DE); Julia Maria Muller, Koln (DE); Matthias Soddemann, Schattdorf (CH); Oskar Nuyken, Munchen (DE); Carola Gantner, Memmingen (DE)

(73) Assignee: LANXESS DEUTSCHLAND GMBH, Leverkusen (DE)

(21) Appl. No.: 13/703,715

(22) PCT Filed: Jun. 14, 2011
(86) PCT No.: PCT/EP2011/059849

§ 371 Date: Jul. 30, 2013

(30) Foreign Application Priority Data
Jun. 14, 2010 (EP) 10165863.1

(51) Int. Cl. C08L 15/00; C08C 19/04

(52) U.S. Cl. CPC C08L 15/005; C08C 19/04
USPC 525/195

(57) ABSTRACT

Novel rubber blends based on partly hydrogenated nitrile rubber and silicone rubber containing vinyl groups are provided, these being produced by a metathesis reaction in the presence of suitable catalysts, as are vulcanizable mixtures and vulcanizates based thereon, and the corresponding production processes.

The invention relates to blends of partly hydrogenated nitrile rubber and silicone rubber, to the production thereof, to vulcanizable mixtures and vulcanizates based thereon, and to the corresponding production processes.

The prior art discloses, in principle, mixtures of fully or partly hydrogenated nitrile rubber and silicone rubber. Such mixtures are of interest for the production of industrial rubber articles which, as well as adequate oil resistance, especially have good cold resistance and high heat resistance. Such mixtures are used for production of seals of all kinds, such as O rings or membrane seals, and of axle boots, hoses, tank linings or spark plug caps, or for lining of curing bladders. However, a problem which occurs in the course of production thereof, which is a typical problem in the production of blends, is that the polymers in some cases have inadequate compatibility. This complicates the blend production, frequently results in poor phase morphology and can accordingly lead to impairment of properties of vulcanizates produced therefrom.

JP 2007/138020 A describes the preparation of thermoplastic elastomers and moulded articles based thereon. A thermoplastic component (b) having a melting point of at least 165° C. and a rubber component (a) composed of a silicone rubber (a1) and a further, different rubber (a2), for example an optionally hydrogenated nitrile rubber, are used. The two rubbers (a1) and (a2) are, in a first step, first dynamically crosslinked using a hydrosilylation crosslinker in the presence of a hydrosilylation catalyst and, in the next step, dynamically crosslinked with the thermoplastic too using conventional peroxide, sulphur or resin crosslinkers. Such blends, however, do not meet all demands placed on them with regard to mechanical properties, especially the low- and high-temperature properties.

JP 05271474 A describes the production of vulcanizable mixtures based on silicone rubber, hydrogenated nitrile rubber, zinc methacrylate and peroxides. The vulcanizates produced therefrom have high ultimate tensile strength, high tensile strain at break and high resilience, combined with high hardness. What are desired, however, are vulcanizates with further improvements in cold and heat stability.

EP-A-0 558 385 describes the production of vulcanizable mixtures based on silicone rubber, hydrogenated nitrile rubber, at least one compound selected from (i) an at least diunsaturated ester or polyester based on (meth)acrylic acid with polyols, (ii) an at least diunsaturated amide or polyamide of (meth)acrylic acid with polyamines, (iii) a C₁-C₈-alkoxysilane having an —NH₂, —SH or unsaturated C═C double bond and (iv) triallyl isocyanurate, and a peroxidic crosslinker and optionally a filler and further additives. The vulcanizates have good mechanical properties, good oil resistance and good cold and heat stability. What are desired, however, are vulcanizates with further improvements in the properties mentioned.

EP-A-0 559 515 describes the production of vulcanizable mixtures based on (a) hydrogenated nitrile rubber (“HNBR”) having at least one type of functional group in the form of carboxyl, carboxylate, carboxylic anhydride or epoxy groups and (b) silicone rubber having at least one type of functional group which can react with the respective type of functional group in the hydrogenated nitrile rubber, for example amino, hydroxyl, carboxyl or epoxy groups. This affords vulcanizable mixtures with good processibility on the roller. The crosslinking is conducted in suitable mixing and kneading units and leads to an increase in the compatibility of the silicone rubber with the hydrogenated nitrile rubber. The vulcanizates produced therefrom have improved ultimate tensile strength, heat and cold stability and oil resistance. A disadvantage is that such functionalized HNBR and silicone rubbers are not universally commercially available and therefore have to be produced in a separate process step.

DE-A-3812 354 describes the production of rubber mixtures based on silicone rubber and hydrogenated nitrile rubber by, in the 1st step, producing two separate mixtures of a) silicone rubber and preferably peroxide and b) hydrogenated nitrile rubber and preferably filler, peroxide, plasticizer and other additives. In the 2nd step, these two mixtures are mixed with one another and then vulcanized. Depending on the proportions of the two rubbers, it is possible to control the swelling characteristics of the vulcanizates in oils and the tear propagation resistance before and after exposure to oil. DE-A-38 12 354, however, does not give any clue as to how the heat and cold stability of such vulcanizates can be improved.

EP-A-0 435 554 describes the production of conductive rubber mixtures from two mixture components (A) and (B), (A) comprising synthetic rubber, for example optionally hydrogenated nitrile rubber, and particular conductive blacks, and (B) consisting of silicone rubber and optionally further components. Mixture components (A) and (B) are produced separately in the 1st step and mixed with one another in a 2nd step. The mixtures are vulcanized with peroxide or with sulphur. The vulcanizates thus produced are notable for high constancy and reproducibility of conductivity. In the examples, the rubber constituent of (A) used is EPDM, butyl rubber and a polysiloxane-modified acrylate rubber, but hydrogenated nitrile rubbers are not used, EP-A-0 435 554 does not contain any pointers as to how vulcanizates based on blends of partly hydrogenated nitrile rubber and silicone rubber with improved mechanical properties and good compression set after storage at high and low temperatures can be produced.

JP 60141738 A describes the production of rubber compounds based on partly hydrogenated nitrile rubber and fluorosilicone rubber, preferably 3,3,3-trifluoropropylmethylpolysiloxane, which are mixed with other mixture constituents and then subjected to peroxidic vulcanization. The fluorosilicone rubber preferably contains certain amounts of methylvinylsiloxane to improve the crosslinking. The vulcanizates have a low degree of volume swelling in the course of storage for 70 h in a toluene/isooctane (6/4) mixture, and good low-temperature characteristics (Gehmann test and compression set). With regard to the dispersion of the two phases, such compounds, however, do not yet meet all demands.

JP 62212143 A describes composite vulcanizates which are produced from layers of rubber blends by co-vulcanization at relatively high temperatures. The rubber blends described are (1) mixtures of hydrogenated nitrile rubber with propylene/tetrafluoroethylene rubber, (2) mixtures of hydrogenated nitrile rubber with halogenated fluoro rubber, (3) mixtures of propylene/tetrafluoroethylene rubber with halogenated fluoro rubber or (4) mixtures of propylene/tetrafluoroethylene rubber with fluorosilicone rubber. The rubber blends additionally contain (based on 100 parts by weight of rubber) 0.1-15 parts by weight of organic peroxide and 1-2 parts by weight of polyfunctional monomers (preferably triallyl isocyanurate). The composite vulcanizates are used for production of seals.

JP 6016872 A describes a vulcanizable rubber mixture which, based on a total of 100 parts by weight of rubber, contains 98-2 parts by weight of hydrogenated nitrile rubber having a Mooney viscosity of <70 ME and an iodine number of <120 and 2-98 parts by weight of silicone rubber and additionally filler based on silica or carbon black in amounts of 200 parts by weight and 0.3-10 parts by weight of a peroxidic crosslinker. A good distribution of the hydrogenated nitrile rubber and of the silicone rubber is achieved by first producing separate component mixtures of the hydrogenated nitrile rubber with filler and peroxide and of the silicone rubber with filler and peroxide, which are then mixed and vulcanized. The resulting vulcanizates have improved mechanical properties, and improvements in cold and heat stability and oil resistance. What are desired, however, are further improvements in the mechanical properties and in the heat and cold stability.

JP 6263923 A describes a mixture of three obligatory components, (A) partly hydrogenated nitrile rubber, (B) polyvinyl chloride and (C) silicone rubber. Vulcanizates are obtained therefrom by kneading components (A) and (B) and subsequently adding (C), with addition of an organic peroxide for vulcanization. The vulcanizates have good heat stability and ozone and weathering resistance, and also good abrasion resistance and oil resistance. JP 06263923 does not reveal how the compression set at high and low temperature of blends based on partly hydrogenated nitrile rubber and silicone rubber can be improved.

JP 10168232 A describes mixtures of 100 parts by weight of hydrogenated nitrile rubber, a crosslinker and 0.2 to 2.0 parts by weight of silicone oil. Vulcanizates obtained therefrom after peroxidic vulcanization have low tack and high fuel resistance, and are used for inner lining of fuel-resistant storage vessels. The silicone oil used is a polymer with low molar mass and not a high molecular weight silicone rubber. The silicone oil does not contain any vinyl groups and is not chemically fixed in the vulcanization. As a result, the efficacy thereof as a mould release agent is preserved even after the vulcanization.

US 2002/053379 A1 describes the attachment of substances to surfaces by first applying a catalyst to a surface and then contacting the substance to be attached therewith and binding it to this surface by a metathesis reaction. The preferred metathesis reaction is the ring-opening metathesis polymerization (ROMP) of monomers such as norbornene and norbornene derivatives such as ethylidenenorbornene using known catalysts. Another possibility is acyclic diene metathesis (ADMET). According to the teaching of US 2002/053379 A1, the process is used either for coating of surfaces or for bonding of two different surfaces or substrates. Possible examples include the production of rubber/metal parts, of fiber/elastomer composites or of cord/elastomer composites, and the provision of tyre carcasses with tread mixtures, i.e. for re-treading of truck tyres. General mention is made of the attachment of elastomers such as hydrogenated nitrile rubber or silicone rubber or mixtures thereof to metal surfaces. There is no disclosure or suggestion of whether and how improved high- and low-temperature properties can be achieved in the case of blends of partly hydrogenated nitrile rubber and silicone rubber.

EP-A-1 505 114 describes rubber mixtures based on hydrogenated nitrile rubber, to which are added, for the purpose of increasing flowability and hence improving processibility, organopolysiloxanes having hydrocarbyl radicals having fewer than 4 carbon atoms. The mixtures preferably additionally comprise a crosslinker and optionally further additives. The mixtures are used for the production of rubber parts which find use in the automotive, oil and electrical industries. EP-A-1 505 114 does not give any pointers whatsoever as to how an improvement in the modulus level and in the compression set at low and high temperatures can be achieved for vulcanizates based on partly hydrogenated NBR and silicone rubber containing vinyl groups.

WO-A-2008/044063 describes a mouldable elastomer composition which consists of the dispersion of a crosslinked organic polymer (e.g. EPDM or HNBR) in uncrosslinked silicone rubber. This elastomer composition is produced, in a 1st stage, by crosslinking EPDM or HNBR by means of a phenol/formaldehyde resin crosslinker in the silicone rubber matrix. The silicone rubber matrix is subsequently vulcanized in a 2nd stage with peroxide or by platinum-catalysed hydrosilylation. The elastomer composition is used for the production of curing bladders, spark plug caps and for ceramifiable coatings of cables and wires of emergency lighting systems. WO-A-2008/044063 does not contain any pointers as to how an increase in the modulus and an improvement in the compression set of vulcanizates can be achieved at high and low temperatures.

WO-A-2005/059008 describes the dynamic vulcanization of an elastomer mixture, wherein, in step (I), an organic rubber (A), an optional compatibilizer (B), an optional catalyst (C), an organopolysiloxane (D), an optional crosslinker, for example an organohydrido compound (E), a vulcanizing agent (F), which may be a Pt catalyst, are mixed and, in a second step, the organopolysiloxane is dynamically crosslinked. It is stated that the organic rubbers (A) used may be all rubbers which do not contain any inorganic constituents such as fluorine or silicon. Nitrile rubbers and hydrogenated nitrile rubbers are mentioned as possible organic rubbers, but partly hydrogenated nitrile rubbers are not. It is stated that the dynamic vulcanization can be performed either by free-radical means with peroxides or by hydrosilylation with Pt catalysts or by polycondensation with tin catalysts. For the performability of the hydrosilylation and the polycondensation, the presence of particular functional groups both in organic rubber (A) and in the silicone rubber (D) is necessary. The examples of WO-A-2005/059008 use exclusively EPDM as the organic rubber (A). The vulcanizates are characterized exclusively by the mechanical properties at room temperature; there are no details of the heat and cold stability of the products. No conclusions can be drawn from WO-A-2005/059008 about the improvement of the properties of vulcanizates based on partly hydrogenated nitrile rubber and silicone rubber.

WO-A-2008/027283 describes the preparation of block copolymers by treating two or more chemically different ethylenically unsaturated polymers with a metathesis catalyst. According to the examples of WO-A-2008/027283, the metathesis is conducted exclusively in the presence of toluene or tetrachloroethane as the solvent. The description describes the cross-metathesis of hydrogenated polybutadiene and HNBR or of an unsaturated polycarbonate with an unsaturated polysiloxane, but a cross-metathesis of partly hydrogenated HNBR with vinylsilicone rubber and a subsequent vulcanization is not described or suggested. WO-A-2008/027283 is directed to the use of the block copolymers for production of mouldable resins and adhesives, and does not give any information as to whether and how the mechanical properties and the compression set at low and high temperature of mouldings based on vulcanizates formed from partly hydrogenated nitrile rubber and silicone rubber can be improved.

A common factor of the aforementioned prior art is that no clues can be inferred therefrom as to how an improvement in the properties of vulcanizates formed from hydrogenated nitrile rubber and silicone rubber can be achieved, especially an improved modulus level and improved properties at high and low temperatures.

It was thus an object of the present invention to provide vulcanizates based on partly hydrogenated nitrile rubber and silicone rubber containing vinyl groups, which have improved mechanical properties, especially an improved modulus level, and improved properties at high and low temperatures.

The object was achieved, surprisingly, by subjecting partly hydrogenated nitrile rubber and silicone rubber containing vinyl groups to a metathesis with addition of suitable catalysts, preferably without solvent. By mixing the resulting blend with further constituents and subsequent vulcanization with peroxides, it is possible to obtain vulcanizates with the desired improved properties.

The invention thus provides a process for producing a rubber blend by mixing at least one partly hydrogenated nitrile rubber and at least one silicone rubber containing vinyl groups with one another, characterized in that the mixing is effected in the presence of a metathesis catalyst which is a complex catalyst which is based on a metal of transition group 6 or 8 of the Periodic Table and has at least one ligand bound in a carbene-like manner to the metal.

The process according to the invention for producing a rubber blend is preferably performed essentially without organic solvents.

In the context of this application, the statement that the process is performed essentially without organic solvents is understood to mean that, in the preferred production of the rubber blend by mixing at least one partly hydrogenated nitrile rubber and at least one silicone rubber containing vinyl groups in the presence of the metathesis catalyst, the amount of organic solvent is not more than 1200 ppm, preferably not more than 500 ppm and especially not more than 100 ppm. Organic solvents are understood to mean aliphatic, cycloaliphatic or aromatic hydrocarbons having 1 to 14 and preferably 1-12 carbon atoms. These aliphatic, cycloaliphatic or aromatic C₁-C₁₄ hydrocarbons may be mono- or polyhalogenated and contain one or more further functional groups, especially hydroxyl, CN, carboxyl, carboxylate, or else one or more heteroatoms, preferably oxygen or nitrogen.

An important factor in the process according to the invention is the use of the metathesis complex catalyst which is based on a metal of transition group 6 or 8 of the Periodic Table and has at least one ligand bound in a carbene-like manner to the metal. Such catalysts are known in principle and are already used to reduce the molecular weight of nitrile rubbers by metathesis. The catalyst for use in accordance with the invention is therefore also referred to hereinafter as “metathesis catalyst” for short.

It is advantageous that vulcanizates based on the inventive blends are produced using peroxides; the presence of other customary crosslinker systems in the form of sulphur, sulphur-releasing systems or phenol-formaldehyde resin-based systems, as used in some cases in the prior art described above, is not required.

The invention further provides the thus obtainable rubber blend based on at least one partly hydrogenated nitrile rubber and at least one silicone rubber containing vinyl groups.

These rubber blends differ from the known rubber blends. The cross-metathesis results in covalent attachment of the partly hydrogenated nitrile rubber to the silicone rubber; very good interdistribution of the two rubbers can thus be achieved.

The invention also provides vulcanizable mixtures comprising the aforementioned rubber blend and at least one peroxidic crosslinking system. They may further comprise one or more additional rubber additives.

The invention further provides a process for producing vulcanizates by subjecting the aforementioned vulcanizable mixtures to a crosslinking reaction, and the resulting vulcanizates.

The prior art has to date not described any vulcanizates which are produced on the basis of blends of partly hydrogenated nitrile rubber and silicone rubber containing vinyl groups.

These inventive vulcanizates feature equally good or improved mechanical properties, especially an increased and hence improved modulus level and improved compression sets both at high and at low temperatures. This is found in comparison with vulcanizates formed from blends of partly hydrogenated nitrile rubber and silicone rubber containing vinyl groups which are not produced in the presence of a metathesis catalyst.

In the context of this application and invention, all definitions of radicals, parameters or elucidations given above and below, in general terms or within areas of preference, can be combined with one another in any desired manner, so including between the respective areas and areas of preference.

The term “substituted” used in the context of this application in connection with the various types of metathesis catalysts or compounds of the general formula (I), (Ia), (Ib) or (Ic) means that a hydrogen atom on a given radical or atom is replaced by one of the groups specified in each case, with the proviso that the valency of the given atom is not exceeded and the substitution leads to a stable compound.

### Partly Hydrogenated Nitrile Rubber:

The inventive blends are produced using partly hydrogenated nitrile rubbers. These contain repeat units which derive from at least one conjugated diene and at least one α,β-unsaturated nitrile, where the C═C double bonds from the polymerized diene monomers have been partly hydrogenated, preferably to an extent of at least 50% up to a maximum of 99%, more preferably to an extent of 75 to 98.5%, even more preferably to an extent of 80 to 98% and especially to an extent of 85 to 96%.

The inventive blends can also be produced using partly hydrogenated nitrile rubbers containing repeat units which derive from at least one conjugated diene, at least one α,β-unsaturated nitrile and one or more further copolymerizable termonomers, where the C═C double bonds from the polymerized diene monomers and the further polymerized termonomers have been partly hydrogenated, preferably to an extent of at least 50% up to a maximum of 99%, more preferably to an extent of 75 to 98.5%, even more preferably to an extent of 80 to 98% and especially to an extent of 85 to 96%.

Any conjugated diene can be used. Preference is given to using (C₄-C₆) conjugated dienes. Particular preference is given to 1,3-butadiene, isoprene, 2,3-dimethylbutadiene, piperylene or mixtures thereof. Especially preferred are 1,3-butadiene and isoprene or mixtures thereof. Even more preferred is 1,3-butadiene.

The α,β-unsaturated nitrite used may be any known α,β-unsaturated nitrile, preference being given to (C₃-C₅)-α,β-unsaturated nitriles such as acrylonitrile, methacrylonitrile, ethacrylonitrile or mixtures thereof. Particular preference is given to acrylonitrile.

The further copolymerizable termonomers used may, for example, be aromatic vinyl monomers, preferably styrene, α-methylstyrene and vinylpyridine, fluorinated vinyl monomers, preferably fluoroethyl vinyl ether, fluoropropyl vinyl ether, o-fluoromethylstyrene, vinyl pentafluorobenzoate, difluoroethylene and tetrafluoroethylene, or else copolymerizable antiageing monomers, preferably N-(4-anilinophenyl)acrylamide, N-(4-anilinophenyl)methacrylamide, N-(4-anilinophenyl)cinamide, N-(4-anilinophenyl)crotonamide, N-phenyl-4-(3-vinylbenzyloxy)aniline and N-phenyl-4-(4-vinylbenzyloxy)aniline, and also nonconjugated dienes, such as 4-cyanocyclohexene and 4-vinylcyclohexene, or else alkynes, such as 1- or 2-butyne.

Further copolymerizable termonomers used may be one or more copolymerizable termonomers containing carboxyl groups, for example α,β-unsaturated monocarboxylic acids, esters thereof, α,β-unsaturated dicarboxylic acids, mono- or diesters thereof or the corresponding anhydrides or amides thereof.

The α,β-unsaturated monocarboxylic acids used may preferably be acrylic acid and methacrylic acid. It is also possible to use esters of the α,β-unsaturated monocarboxylic acids, preferably the alkyl esters, alkoxyalkyl esters or hydroxyalkyl esters thereof.

Preference is given to C₁-C₁₈ alkyl esters of the α,β-unsaturated monocarboxylic acids, particular preference to C₁-C₁₈ alkyl esters of acrylic acid and methacrylic acid, especially preferably methyl(meth)acrylate, ethyl(meth)acrylate, propyl(meth)acrylate, n-butyl(meth)acrylate, t-butyl(meth)acrylate, hexyl(meth)acrylate, 2-ethylhexyl(meth)acrylate, octyl(meth)acrylate, n-dodecyl(meth)acrylate, 2-propylheptyl acrylate and lauryl(meth)acrylate. In particular, n-butyl acrylate is used.

Preference is also given to C₂-C₁₂-alkoxyalkyl esters of the α,β-unsaturated monocarboxylic acids, particular preference to C₂-C₁₂. alkoxyalkyl esters of acrylic acid or of methacrylic acid, especially methoxymethyl(meth)acrylate, methoxyethyl(meth)acrylate, ethoxyethyl(meth)acrylate and methoxyethyl(meth)acrylate. In particular, methoxyethyl acrylate is used.

Preference is also given to C₁-C₁₂-hydroxyalkyl esters of the α,β-unsaturated monocarboxylic acids, particular preference to C₁-C₁₂-hydroxyalkyl esters of acrylic acid or methacrylic acid, especially 2-hydroxyethyl(meth)acrylate, 3-hydroxypropyl(meth)acrylate and hydroxybutyl(meth)acrylate.

Other esters of the α,β-unsaturated monocarboxylic acids used are additionally, for example, polyethylene glycol(meth)acrylate, polypropylene glycol(meth)acrylate, glycidyl(meth)acrylate, epoxy(meth)acrylate, N-(2-hydroxyethyl)acrylamide, N-(2-hydroxymethyl)acrylamide and urethane(meth)acrylate.

It is also possible to use mixtures of alkyl esters, for example those mentioned above, with alkoxyalkyl esters, for example in the form of those mentioned above.

It is also possible to use cyanoalkyl acrylates and cyanoalkyl methacrylates in which the number of carbon atoms in the cyanoalkyl group is 2-12, preferably α-cyanoethyl acrylate, β-cyanoethyl acrylate and cyanobutyl methacrylate.

It is also possible to use fluorine-substituted acrylates or methacrylates containing benzyl groups, preferably fluorobenzyl acrylate and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Further copolymerizable monomers used may be α,β-unsaturated dicarboxylic acids, preferably maleic acid, fumaric acid, crotonic acid, itaconic acid, citraconic acid and mesaconic acid.

It is additionally possible to use α,β-unsaturated dicarboxylic anhydrides, preferably maleic anhydride, itaconic anhydride, citraconic anhydride and mesaconic anhydride.

It is additionally possible to use mono- or diesters of α,β-unsaturated dicarboxylic acids. These α,β-unsaturated dicarboxylic mono- or diesters may, for example, be alkyl, preferably C₁-C₁₀-alkyl, especially ethyl, n-propyl, isopropyl, n-butyl, tert-butyl, n-pentyl or n-hexyl, alkoxyalkyl, preferably C₂-C₁₂-alkoxyalkyl, more preferably C₃-C₈-alkoxyalkyl, hydroxyalkyl, preferably C₁-C₁₂-hydroxyalkyl, more preferably C₂-C₈-hydroxyalkyl, cycloalkyl, preferably C₅-C₁₂-cycloalkyl, more preferably C₆-C₁₂-cycloalkyl, alkylcycloalkyl, preferably C₆-C₁₂-alkylcycloalkyl, more preferably C₇-C₁₀-alkylcycloalkyl, or aryl, preferably C₆-C₁₄-aryl mono- or diesters, where the diesters in each case may also be uniform or mixed esters.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconates, preferably monobenzyl citraconate;
monoalkyl itaconates, preferably monomethyl itaconate, monoethyl itaconate, monopropyl itaconate and mono-n-butyl itaconate;
monocycloalkyl itaconates, preferably monocyclopentyl itaconate, monocyclohexyl itaconate and monocycloheptyl itaconate;
monoalkylcycloalkyl itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The α,β-unsaturated dicarboxylic diesters used may be the analogous diesters based on the aforementioned monoester groups, where the ester groups may also be chemically different groups.

The proportions of repeat units in the partly hydrogenated NBR polymers based on the conjugated diene and α,β-unsaturated nitrile may vary within wide ranges. The proportion of, or of the sum of, the conjugated diene(s) is typically in the range from 40 to 90% by weight, preferably in the range from 50 to 88% by weight, based on the overall polymer. The proportion of, or of the sum of, the α,β-unsaturated nitrile(s) is typically in the range from 10 to 60% by weight, preferably 15 to 50% by weight, based on the overall polymer. The proportions of the monomers in each case add up to 100% by weight. The additional termonomers may, according to the nature of the termonomer(s), be present in amounts of 0 to 40% by weight, based on the overall polymer. In this case, corresponding proportions of the conjugated diene(s) and/or of the α,β-unsaturated nitrile(s) are replaced by the proportions of the additional monomers, where the proportions of all monomers in each case add up to 100% by weight.

The partly hydrogenated nitrile rubbers used in accordance with the invention have a Mooney viscosity (ML 1+4 at 100° C.) in the range from 10 to 120 Mooney units, preferably of 20 to 100 Mooney units. The Mooney viscosity is determined to ASTM Standard D 1646.

If, in accordance with the invention, nitrile rubbers with a Mooney viscosity (ML 1+4 at 100° C.) in the range from 30 to 70, preferably from 30 to 50, are used, this corresponds to a weight-average molecular weight Mw in the range of 150 000-500 000, preferably in the range of 180 000-400 000, and the polydispersity PDI=Mw/Mn where Mw is the weight-average and Mn the number-average molecular weight, is typically in the range of 2.0-6.0, preferably in the range of 2.0-4.0.

Such partly hydrogenated nitrile rubbers are sufficiently well-known to the person skilled in the art and are either commercially available, for example under the Therban® brand from Lanxess Deutschland GmbH, or are producible by methods familiar to those skilled in the art. Partly hydrogenated nitrile rubbers are typically produced by emulsion polymerization followed by a hydrogenation, the production being familiar to the person skilled in the art and being known from a multitude of references and patents.

### Silicone Rubber Containing Vinyl Groups:

The silicone rubbers containing vinyl groups used may be any of those known from the literature to the person skilled in the art. For example, they may be organopolysiloxanes containing two or more types of repeat units of the general formula (I)

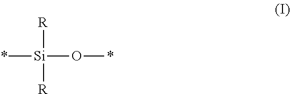

in which, in each case,
R are the same or different and are each an unsubstituted or substituted monovalent hydrocarbyl radical having 1 to 6 carbon atoms, and
   where the organopolysiloxane has a total of 10 to 20 000, preferably 50 to 15 000 and more preferably 200 to 10 000 repeat units, and at least one of the R radicals in one of the types of repeat units of the general formula (I) contains one or more C═C double bonds.

Where the R radical(s) in the repeat units of the general formula (I) is/are not the radical containing one or more C═C double bonds, these R radicals may be the same or different and may each be straight-chain or branched C₁-C₆-alkyl or phenyl. The C₁-C₆-alkyl radical may be mono-, di-, tri- or more than trisubstituted by halogen, preferably fluorine.

Preference is given to using those organopolysiloxanes which have one type of repeat unit of the general formula (II)

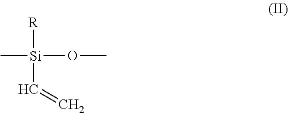

in which R is as defined for the formula (I), and one or more further types of repeat unit of the general formula (I).

It has been found to be useful to use organopolysiloxanes of the general formula (I) in which 0.1 to 50 mol %, preferably 0.5 to 20 mol % and more preferably 1 to 10 mol % of all R radicals present in the repeat units are vinyl groups (—CH═CH₂).

The structure of the organopolysiloxanes is uncritical; it is possible to use organopolysiloxanes either with straight-chain or with partly branched or cyclic structures.

The end groups of the organopolysiloxanes are typically radicals of the type

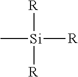

where the R radicals are as defined for the general formula (I) and may each independently also be H, OR′ and C(═O)R′ in which R′ may again be as defined for the R radicals for the general formula (I).

It is also possible that an R radical bonded to one of the chain-terminal silicon atoms, together with a second R radical bonded to the second terminal silicon atom, forms a single bond, resulting in the formation of an organosiloxane ring.

Due to the proviso that the silicone rubbers to be used always contain one type of repeat unit containing an R radical having C═C double bonds, they are copolymers or polymers based on three or more monomers. It is possible to use, for example, copolymers which, as well as the repeat units containing the C═C double bond(s) in the R radical, have preferably methylvinylsiloxy repeat units, dimethylsiloxy, phenylmethylsiloxy, diphenylsiloxy and/or 3,3,3-trifluoropropylmethylsiloxy repeat units.

Silicone rubbers which contain vinyl groups and are to be used with preference are known by the following general names:
VMQ (vinylmethylsilicone rubber)
PVMQ (phenylvinylmethylsilicone rubber)
FVMQ (3,3,3-trifluoropropylvinylmethylsilicone rubber)

The proportion of the respective types of repeat units in these silicone rubbers can vary to degrees known to those skilled in the art.

It has been found to be useful to use VMQ, PVMQ and FVMQ as shown in the formulae below, in which n and m are identical or different integers and are typically each in the range from 1 to 9999, preferably 1 to 7499 and more preferably 1 to 4999, and in which c is an integer and in each case is in the range from 10 to 10 000, preferably 50 to 7500 and more preferably 100 to 5000, with the proviso that n, m and c assume such values that the sum of all repeat units in the particular organopolysiloxane is 10 to 20 000, preferably 50 to 15 000, more preferably 200 to 10 000.

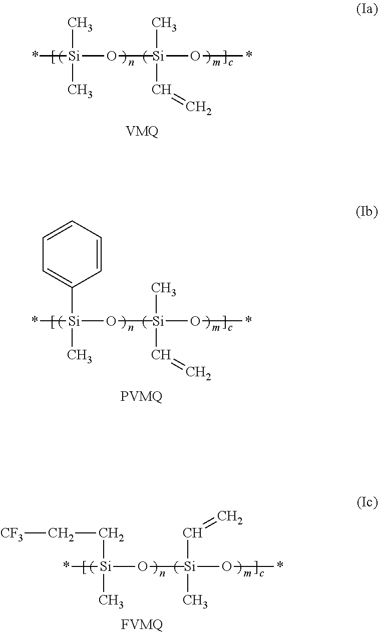

Such silicone rubbers containing vinyl groups are also commercially available or preparable by methods known to those skilled in the art.

The inventive rubber blend is preferably produced using at least one partly hydrogenated nitrite rubber containing repeat units which derive from at least one conjugated diene and at least one α,β-unsaturated nitrile, where the C═C double bonds from the polymerized diene monomers have been partly hydrogenated, preferably to an extent of at least 50% up to a maximum of 99%, more preferably to an extent of 75 to 98.5%, even more preferably to an extent of 80 to 98% and especially to an extent of 85 to 96%, and at least one organopolysiloxane containing vinyl groups and containing two or more types of repeat unit of the general formula (I)

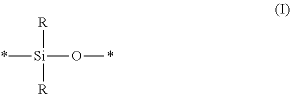

in which R are the same or different and are each a substituted or unsubstituted monovalent hydrocarbyl radical having 1 to 6 carbon atoms, preferably straight-chain or branched C₁-C₆ alkyl optionally substituted by one or more fluorine radicals, or phenyl or vinyl,
   where the organopolysiloxane has a total of 1 to 20 000 repeat units, preferably 50 to 15 000 and more preferably 200 to 10 000 repeat units, and one type of repeat units of the general formula (I) in which at least one of the R radicals contains one or more C═C double bonds is present.

The inventive rubber blend is more preferably produced using at least one acrylonitrile-butadiene copolymer in which 75 to 98.5%, even more preferably 80 to 98% and especially 85 to 96% of the C═C double bonds have been hydrogenated, and at least one silicone rubber containing vinyl groups and selected from the group consisting of VMQ (vinylmethylsilicone rubber), PVMQ (phenylvinylmethylsilicone rubber) and FVMQ (3,3,3-trifluoropropylvinylmethylsilicone rubber).

### Metathesis Catalysts:

The metathesis catalysts to be used in accordance with the invention are tried and tested complex catalysts based on molybdenum, osmium or ruthenium. These complex catalysts have the common structural feature that they have at least one ligand bound in a carbene-like manner to the metal. In a preferred embodiment, the complex catalyst has two carbene ligands, i.e. two ligands bound in a carbene-like manner to the central metal of the complex.

It is possible to use, for example, a catalyst of the general formula (A)

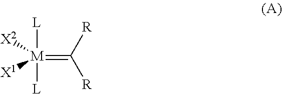

in which
M is osmium or ruthenium,
X¹ and X² are the same or different and are two ligands, preferably anionic ligands,
L are identical or different ligands, preferably uncharged electron donors,
R are the same or different and are each hydrogen, alkyl, preferably C₁-C₃₀-alkyl, cycloalkyl, preferably C₃-C₂₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where all these radicals may each optionally be substituted by one or more alkyl, halogen, alkoxy, aryl or heteroaryl radicals, or alternatively both R radicals together with the common carbon atom to which they are bonded are bridged to form a cyclic group which may be aliphatic or aromatic in nature, is optionally substituted and may contain one or more heteroatoms.

In preferred catalysts of the general formula (A), one R radical is hydrogen and the other R radical is C₁-C₂₀-alkyl, C₃-C₁₀-cycloalkyl, C₂-C₂₀-alkenyl, C₂-C₂₀-alkynyl, C₆-C₂₄-aryl. C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl or C₁-C₂₀-alkylsulphinyl, where all these radicals may each optionally be substituted by one or more alkyl, halogen, alkoxy, aryl or heteroaryl radicals.

In the catalysts of the general formula (A), X¹ and X² are the same or different and are two ligands, preferably anionic ligands.

X¹ and X² may, for example, be hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₂₀-alkylsulphonyl or C₁-C₂₀-alkylsulphinyl radicals.

The aforementioned X¹ and X² radicals may also be substituted by one or more further radicals, for example by halogen, preferably fluorine, C₁-C₁₀-alkyl, C₁-C₁₀-alkoxy or C₆-C₂₄-aryl, where these radicals too may optionally in turn be substituted by one or more substituents selected from the group comprising halogen, preferably fluorine, C₁-C₅-alkyl, C₁-C₅-alkoxy and phenyl. In a preferred embodiment, X¹ and X² are the same or different and are each halogen, especially fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate. In a particularly preferred embodiment, X¹ and X² are identical and are each halogen, especially chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (2,4,6-trimethylphenyl) or CF₃SO₃ (trifluoromethanesulphonate).

In the general formula (A), L are identical or different ligands and are preferably uncharged electron donors.

The two L ligands may, for example, each independently be a phosphine, sulphonated phosphine, phosphate, phosphinite, phosphonite, arsine, stibine, ether, amine, amide, sulphoxide, carboxyl, nitrosyl, pyridine, thioether or imidazolidine (“Im”) ligand.

The two L ligands are preferably each independently C₆-C₂₄-aryl-, C₁-C₁₀-alkyl- or C₃-C₂₀-cycloalkylphosphine ligand, a sulphonated C₆-C₂₄-aryl- or sulphonated C₁-C₁₀-alkylphosphine ligand, a C₆-C₂₄-aryl- or C₁-C₁₀-alkylphosphinite ligand, a C₆-C₂₄-aryl- or C₁-C₁₀-alkylphosphonite ligand, a C₆-C₂₄-aryl- or C₁-C₁₀-alkylphosphite ligand, a C₆-C₂₄-aryl- or C₁-C₁₀-alkylarsine ligand, a C₆-C₂₄-aryl- or C₁-C₁₀-alkylamine ligand, a pyridine ligand, a C₆-C₂₄-aryl- or C₁-C₁₀-alkylsulphoxide ligand, a C₆-C₂₄-aryl or C₁-C₁₀-alkyl ether ligand or a C₆-C₂₄-aryl- or C₁-C₁₀-alkylamide ligand, all of which may each be substituted by a phenyl group which is in turn optionally substituted by a halogen, C₁-C₅-alkyl or C₁-C₅-alkoxy radical.

The term “phosphine” includes, for example, PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃.

The term “phosphinite” includes, for example, triphenylphosphinite, tricyclohexylphosphinite, triisopropylphosphinite and methyldiphenylphosphinite.

The term “phosphite” includes, for example, triphenylphosphite, tricyclohexylphosphite, tri-tert-butylphosphite, triisopropylphosphite and methyldiphenylphosphite.

The term “stibine” includes, for example, triphenylstibine, tricyclohexylstibine and trimethylstibine.

The term “sulphonate” includes, for example, trifluoromethanesulphonate, tosylate and mesylate.

The term “sulphoxide” includes, for example, (CH₃)₂S(═O) and (C₆H₅)₂S═O.

The term “thioether” includes, for example, CH₃SCH₃, C₆H₅SCH₃, CH₃OCH₂CH₂SCH₃ and tetrahydrothiophene.

The term “pyridine” shall be understood in the context of this application as an umbrella term including all nitrogen-containing ligands, as specified, for example, by Grubbs in WO-A-03/011455. Examples thereof are: pyridine, picolines (α-, β-, and γ-picoline), lutidines (2,3-, 2,4-, 2,5-, 2,6-, 3,4- and 3,5-lutidine), collidine (2,4,6-trimethylpyridine), trifluoromethylpyridine, phenylpyridine, 4-(dimethylamino)pyridine, chloropyridines, bromopyridines, nitropyridines, quinoline, pyrimidine, pyrrole, imidazole and phenylimidazole.

When one or both of the L ligands is an imidazolidine radical (Im), this typically has a structure of the general formula (IIa) or (IIb)

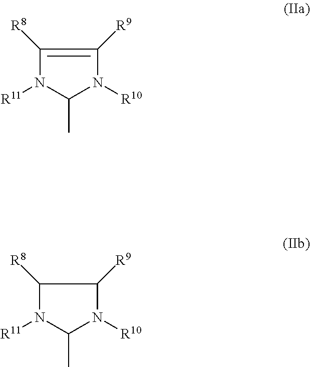

in which
R⁸, R⁹, R¹⁰, R¹¹ are the same or different and are each hydrogen or straight-chain or branched C₁-C₃₀-alkyl, C₃-C₂₀-cycloalkyl, C₂-C₁₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkyl sulphonyl, C₁-C₂₀-alkylsulphonate, C₆-C₂₀-arylsulphonate or C₁-C₂₀-alkyl sulphinyl.

Optionally, one or more of the R⁸, R⁹, R¹⁰, R¹¹ radicals are each independently substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents may each in turn be substituted by one or more radicals, preferably selected from the group of halogen, especially chlorine or bromine, C₁-C₅-alkyl, C₁-C₅-alkoxy and phenyl.

Merely for clarification, it should be added that the structures of the imidazolidine radical shown in the general formulae (IIa) and (IIb) in the context of this application are equivalent to the structures (IIa′) and (IIb′) frequently also encountered in the literature for this imidazolidine radical (Im), which emphasize the carbene character of the imidazolidine radical. This also applies analogously to the corresponding preferred structures (IIIa)-(IIIf) shown below.

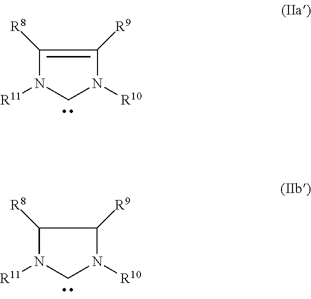

In a preferred embodiment of the catalysts of the general formula (A), R⁸ and R⁹ are each independently hydrogen, C₆-C₂₄-aryl, more preferably phenyl, straight-chain or branched C₁-C₁₀-alkyl, more preferably propyl or butyl, or form, together with the carbon atoms to which they are bonded, a cycloalkyl or aryl radical, where all aforementioned radicals may optionally be substituted in turn by one or more further radicals selected from the group comprising straight-chain or branched C₁-C₁₀-alkyl, C₁-C₁₀-alkoxy, C₆-C₂₄-aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

In a preferred embodiment of the catalysts of the general formula (A), the R¹⁰ and R¹¹ radicals are additionally the same or different and are each straight-chain or branched C₁-C₁₀-alkyl, more preferably isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

More particularly, the R¹⁰ and R¹¹ radicals may be the same or different and are each isopropyl, neopentyl, adamantyl, mesityl or 2,6-diisopropylphenyl.

Particularly preferred imidazolidine radicals (Im) have the structures (IIIa) to (IIIf) below, where Ph in each case is a phenyl radical, Bu is a butyl radical and Mes in each case is a 2,4,6-trimethylphenyl radical, or Mes alternatively in all cases is 2,6-diisopropylphenyl.

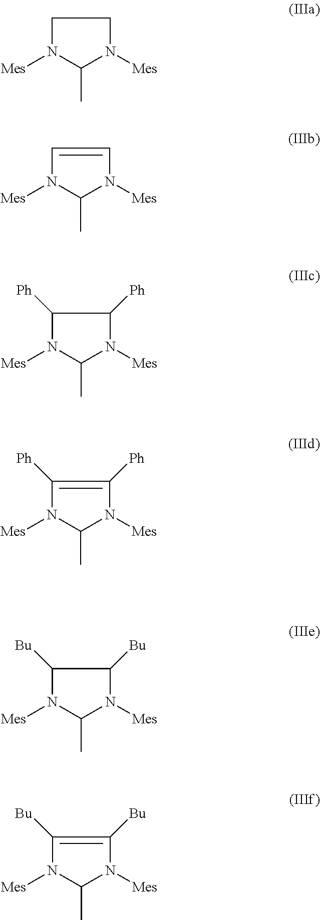

A wide variety of different representatives of the catalysts of the formula (A) is known in principle, for example from WO-A-96/04289 and WO-A-97/06185.

As an alternative to the preferred Im radicals, one or both L ligands in the general formula (A) are preferably also identical or different trialkylphosphine ligands in which at least one of the alkyl groups is a secondary alkyl group or a cycloalkyl group, preferably isopropyl, isobutyl, sec-butyl, neopentyl, cyclopentyl or cyclohexyl.

More preferably, in the general formula (A), one or both L ligands are a trialkylphosphine ligand in which at least one of the alkyl groups is a secondary alkyl group or a cycloalkyl group, preferably isopropyl, isobutyl, sec-butyl, neopentyl, cyclopentyl or cyclohexyl.

Particular preference is given to catalysts which are covered by the general formula (A) and have the structures (IV) (Grubbs (I) catalyst) and (V) (Grubbs (II) catalyst), where Cy is cyclohexyl.

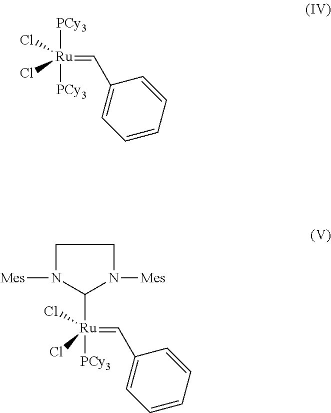

In a further embodiment, a catalyst of the general formula (A1) is used in which

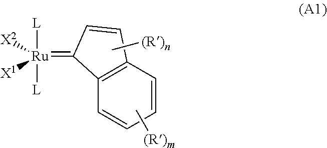

X¹, X² and L may have the same general, preferred and particularly preferred definitions as in the general formula (A),
n is 0, 1 or 2,
m is 0, 1, 2, 3 or 4 and
R′ are the same or different and are each alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each be substituted by one or more alkyl, halogen, alkoxy, aryl or heteroaryl radicals.

An example of a preferred catalyst covered by the general formula (A1) which can be used is that of the formula (VI) below, where Mes in each case is 2,4,6-trimethylphenyl and Ph is phenyl.

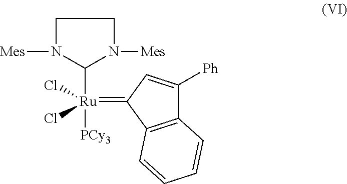

This catalyst, also referred to in the literature as “Nolan catalyst”, is known, for example, from WO-A-2004/112951.

It has also been found to be useful to use a catalyst of the general formula (B)

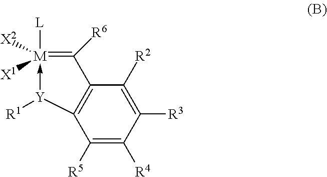

in which
M is ruthenium or osmium,
X¹ and X² are identical or different ligands, preferably anionic ligands,
Y is oxygen (O), sulphur (S), an N—R¹ radical or a P—R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
R², R³, R⁴ and R⁵ are the same or different and are each hydrogen or organic or inorganic radicals,
R⁶ is H or an alkyl, alkenyl, alkynyl or aryl radical and
L is a ligand as defined for the formula (A).

The catalysts of the general formula (B) are known in principle. Representatives of this compound class are the catalysts described by Hoveyda et al. in US 2002/0107138 A1 and Angew. Chem. Int. Ed. 2003, 42, 4592, and the catalysts which are described by Grela in WO-A-2004/035596, Eur. J. Org. Chem 2003, 963-966 and Angew. Chem. Int. Ed. 2002, 41, 4038, and also in J. Org. Chem. 2004, 69, 6894-96 and Chem. Eur. J 2004, 10, 777-784. The catalysts are commercially available or can be prepared according to the references cited.

In the catalysts of the general formula (B), L is a ligand which typically has electron donor function and may assume the same general, preferred and particularly preferred definitions as L in the general formula (A).

In addition, L in the general formula (B) is preferably a P(R⁷)₃ radical where R⁷ is independently C₁-C₆ alkyl, C₃-C₈-cycloalkyl or aryl, or else an optionally substituted imidazolidine radical (“Im”).

C₁-C₆-Alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl comprises cyclopropyl, cyclobutyl, cyclopentyl, cyclohexyl, cycloheptyl and cyclooctyl.

Aryl comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The imidazolidine radical (Im) has a structure of the general formula (IIa) or (IIb)

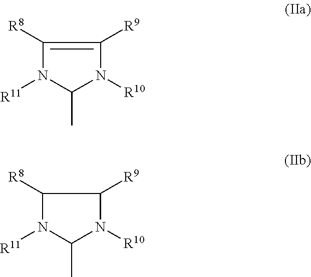

in which
R⁸, R⁹, R¹⁰, R¹¹ are the same or different and are each hydrogen or straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-arylthio, C₆-C₂₀-arylthio, C₁-C₂₀-alkylsulphonyl, C₁-C₂₀-alkylsulphonate, C₆-C₂₀-arylsulphonate or C₁-C₂₀-alkylsulphinyl.

Optionally, one or more of the R⁸, R⁹, R¹⁰, R¹¹ radicals may each independently be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents may each in turn be substituted by one or more radicals, preferably selected from the group of halogen, especially chlorine or bromine, C₁-C₅-alkyl. C₁-C₅-alkoxy or phenyl.

It has been found to be especially useful to use catalysts of the general formula (B) in which R⁸ and R⁹ are each independently hydrogen, C₆-C₂₄-aryl, more preferably phenyl, straight-chain or branched C₁-C₁₀-alkyl, more preferably propyl or butyl, or form, together with the carbon atoms to which they are bonded, a cycloalkyl or aryl radical, where all aforementioned radicals may optionally be substituted in turn by one or more further radicals selected from the group comprising straight-chain or branched C₁-C₁₀-alkyl, C₁-C₁₀-alkoxy, C₆-C₂₄-aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

In a further preferred embodiment, a catalyst of the general formula (B) is used in which the R¹⁰ and R¹¹ radicals are the same or different and are each straight-chain or branched C₁-C₁₀-alkyl, more preferably isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, or C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

More particularly, the R¹⁰ and R¹¹ radicals may be the same or different and are each isopropyl, neopentyl, adamantyl or mesityl.

Particularly preferred imidazolidine radicals (Im) have the structures (IIIa-IIIf) already specified above, where Mes in each case is 2,4,6-trimethylphenyl.

In the catalysts of the general formula (B), X¹ and X² are the same or different and may each, for example, be hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₂₀-alkylsulphonyl or C₁-C₂₀-alkylsulphinyl.

The aforementioned X¹ and X² radicals may also be substituted by one or more further radicals, for example by halogen, preferably fluorine, C₁-C₁₀-alkyl, C₁-C₁₀-alkoxy or C₆-C₂₄-aryl radicals, where these latter radicals too may optionally in turn be substituted by one or more substituents selected from the group comprising halogen, preferably fluorine, C₁-C₅-alkyl, C₁-C₅-alkoxy and phenyl.

In a preferred embodiment, X¹ and X² are the same or different and are each halogen, especially fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a particularly preferred embodiment, X¹ and X² are identical and are each halogen, especially chlorine, CF₃COO, CH₃COO, CFH₂COO, (CH₃)₃CO₃, (CF₃)₂(CH₃)CO, (CF₃)(CH₃)₂CO₃, PhO (phenoxy), MeO (methoxy), EtO (ethoxy), tosylate (p-CH₃—C₆H₄—SO₃), mesylate (2,4,6-trimethylphenyl) or CF₃SO₃ (trifluoromethanesulphonate).

In the general formula (B), the R¹ radical is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals.

Typically, the R¹ radical is a C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radical, all of which may each optionally be substituted by one or more alkyl, halogen, alkoxy, aryl or heteroaryl radicals.

Preferably, R¹ is a C₃-C₂₀-cycloalkyl radical, a C₆-C₂₄-aryl radical or a straight-chain or branched C₁-C₃₀-alkyl radical, where the latter may optionally be interrupted by one or more double or triple bonds or else one or more heteroatoms, preferably oxygen or nitrogen. More preferably, R¹ is a straight-chain or branched C₁-C₁₂-alkyl radical.

The C₃-C₂₀-cycloalkyl radical comprises, for example, cyclopropyl, cyclobutyl, cyclopentyl, cyclohexyl, cycloheptyl and cyclooctyl.

The C₁-C₁₂-alkyl radical may, for example, be methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, n-heptyl, n-octyl, n-decyl or n-dodecyl. More particularly, R¹ is methyl or isopropyl.

The C₆-C₂₄-aryl radical is an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

In the general formula (B), the R², R³, R⁴ and R⁵ radicals are the same or different and may be hydrogen or organic or inorganic radicals.

In a suitable embodiment, R², R³, R⁴, R⁵ are the same or different and are each hydrogen, halogen, nitro, CF₃, alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each optionally be substituted by one or more alkyl, alkoxy, halogen, aryl or heteroaryl radicals.

Typically, R², R³, R⁴, R⁵ are the same or different and are each hydrogen, halogen, preferably chlorine or bromine, nitro, CF₃, C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radicals, each of which may optionally be substituted by one or more C₁-C₃₀-alkyl, C₁-C₂₀-alkoxy, halogen, C₆-C₂₄-aryl or heteroaryl radicals.

In a particularly useful embodiment, R², R³, R⁴, R⁵ are the same or different and are each nitro, straight-chain or branched C₁-C₃₀-alkyl, C₅-C₂₀-cycloalkyl, straight-chain or branched C₁-C₂₀-alkoxy radicals or C₆-C₂₄-aryl radicals, preferably phenyl or naphthyl. The C₁-C₃₀-alkyl radicals and C₁-C₂₀-alkoxy radicals may optionally be interrupted by one or more double or triple bonds or else one or more heteroatoms, preferably oxygen or nitrogen.

In addition, two or more of the R², R³, R⁴ or R⁵ radicals may also be bridged via aliphatic or aromatic structures. R³ and R⁴ may, for example, including the carbon atoms to which they are bonded in the phenyl ring of the formula (B), form a fused-on phenyl ring so as to result overall in a naphthyl structure.

In the general formula (B), the R⁶ radical is hydrogen or an alkyl, alkenyl, alkynyl or aryl radical. Preferably, R⁶ is H or a C₁-C₃₀-alkyl, a C₂-C₂₀-alkenyl, a C₂-C₂₀-alkynyl or a C₆-C₂₄-aryl radical. More preferably, R⁶ is hydrogen.

Additionally suitable are catalysts according to the general formula (B1)

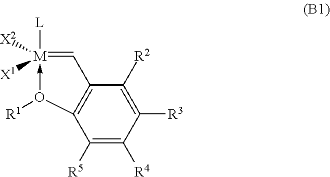

in which
M, L, X¹, X², R¹, R², R³, R⁴ and R⁵ may each have the general, preferred and particularly preferred definitions given for the general formula (B).

The catalysts of the general formula (B1) are known in principle, for example, from US 2002/0107138 A1 (Hoveyda et al.) and can be obtained by preparation processes specified therein.

Particular preference is given to catalysts of the general formula (B1) in which
M is ruthenium,
X¹ and X² are both halogen, especially both chlorine,
R¹ is a straight-chain or branched C₁-C₁₂ alkyl radical,
R², R³, R⁴, R⁵ each have the general and preferred definitions given for the general formula (B) and
L has the general and preferred definitions given for the general formula (B).

Especially preferred catalysts are those of the general formula (B1) where
M is ruthenium,
X¹ and X² are both chlorine,
R¹ is an isopropyl radical,
R², R³, R⁴, R⁵ are all hydrogen and
L is an optionally substituted imidazolidine radical of the formula (IIa) or (IIb)

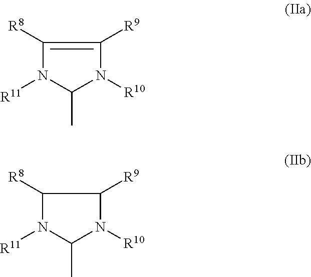

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₆-C₂₄-arylthio, C₁-C₂₀-alkylsulphonyl, C₁-C₂₀-alkylsulphonate, C₆-C₂₄-arylsulphonate or C₁-C₂₀-alkylsulphinyl, where the aforementioned radicals may each be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents too may in turn each be substituted by one or more radicals, preferably selected from the group of halogen, especially chlorine or bromine, C₁-C₅-alkyl, C₁-C₅-alkoxy and phenyl.

Very particular preference is given to a catalyst which is covered by the general structural formula (B1) and has the formula (VII), where Mes in each case is 2,4,6-trimethylphenyl.

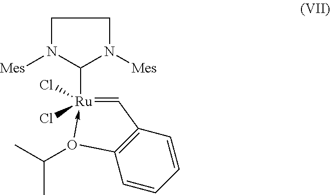

This catalyst (VII) is also referred to in the literature as “Hoveyda catalyst”.

Further suitable catalysts are those which are covered by the general structural formula (B1) and have one of the following formulae (VIII), (IX), (X), (XI), (XII), (XIII), (XIV) and (XV), where Mes in each case is 2,4,6-trimethylphenyl.

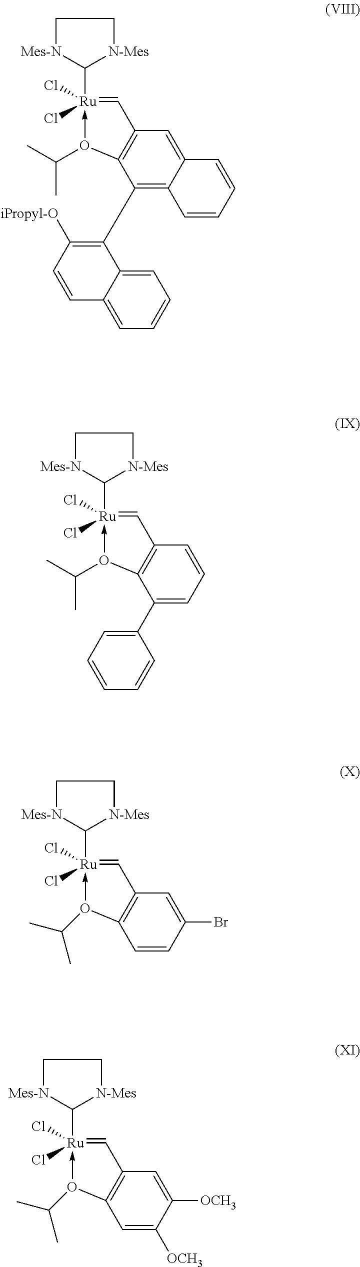

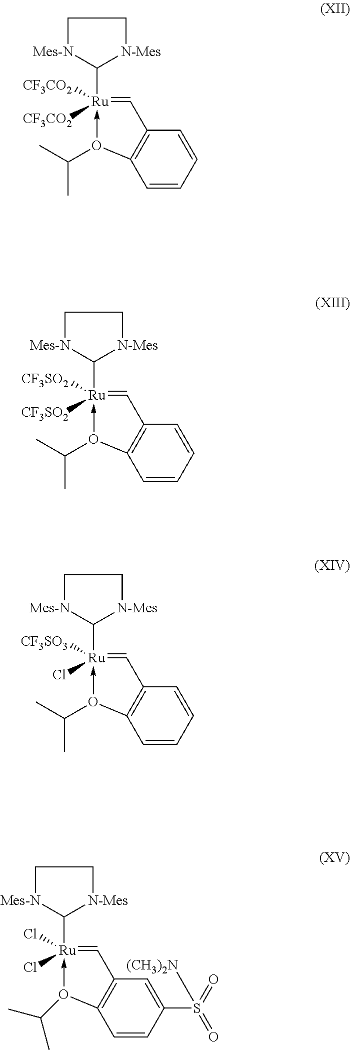

A further suitable catalyst has the general formula (B2)

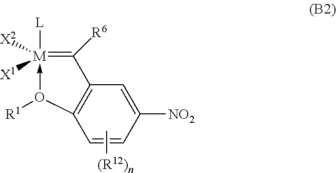

in which
M, L, X¹, X², R¹ and R⁶ each have the general and preferred definitions given for the formula (B),
R¹² are the same or different and have the general and preferred definitions given for the R², R³, R⁴ and R⁵ radicals in the formula (B), excluding hydrogen, and
n is 0, 1, 2 or 3.

The catalysts of the general formula (B2) are known in principle, for example, from WO-A-2004/035596 (Grela) and can be obtained by preparation processes specified therein.

Particular preference is given to catalysts of the general formula (B2) where
M is ruthenium,
X¹ and X² are both halogen, especially both chlorine,
R¹ is a straight-chain or branched C₁-C₁₂ alkyl radical,
R¹² is as defined for the general formula (B2),
n is 0, 1, 2 or 3,
R⁶ is hydrogen and
L is as defined for the general formula (B).

Especially preferred catalysts are those of the general formula (B2) where
M is ruthenium,
X¹ and X² are both chlorine,
R¹ is an isopropyl radical,
n is 0 and
L is an optionally substituted imidazolidine radical of the formula (IIa) or (IIb) in which R⁸, R⁹, R¹⁰, R¹¹ are the same or different and are each as defined for the especially preferred catalysts of the general formula (B1).

A particularly suitable catalyst is one of the following structure (XVI)

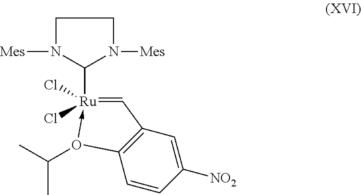

The catalyst (XVI) is also referred to in the literature as “Grela catalyst”.

A further suitable catalyst covered by the general formula (B2) has the following structure (XVII), where Mes in each case is 2,4,6-trimethylphenyl.

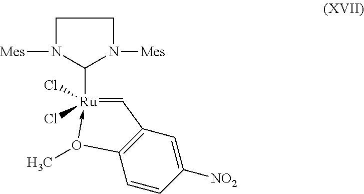

Alternatively, it is also possible to use a dendritic catalyst of the general formula (B3)

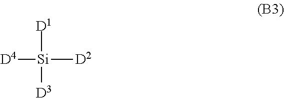

in which D¹, D², D³ and D⁴ each have a structure of the general formula (XVIII) shown below which is attached to the silicon of the formula (B3) via the methylene group shown on the right, and

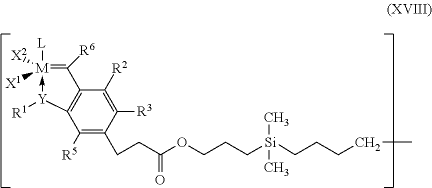

in which
M, L, X¹, X², R¹, R², R³, R⁵ and R⁶ may each have the general and preferred definitions given for the general formula (B).

The catalysts according to the general formula (B3) are known from US 2002/0107138 A1 and can be prepared according to the details given therein.

A further alternative embodiment relates to a catalyst of the formula (B4)

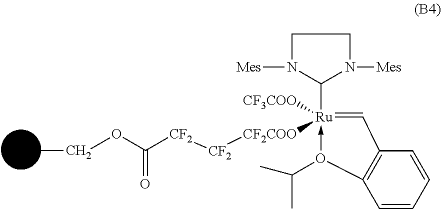

in which the symbol represents a support.

The support is preferably a poly(styrene-divinylbenzene) copolymer (PS-DVB).

The catalysts according to formula (B4) are known in principle from Chem. Eur. J. 2004 10, 777-784 and are obtainable by preparation methods described therein.

All aforementioned type (B) catalysts can either be added as such to the mixture of the partly hydrogenated nitrile rubber and the silicone rubber containing vinyl groups or else be applied to a solid support and immobilized. Suitable solid phases or supports are those materials which are firstly inert with respect to the metathesis reaction mixture and secondly do not impair the activity of the catalyst. The catalyst can be immobilized using, for example, metals, glass, polymers, ceramic, organic polymer beads or else inorganic sol-gels, carbon black, silica, silicates, calcium carbonate and barium sulphate.

A further embodiment relates to a catalyst of the general formula (C)

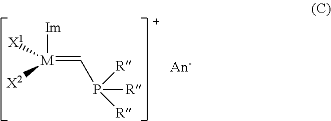

where
M is ruthenium or osmium,
X¹ and X² are the same or different and are each anionic ligands.
R″ are the same or different and are each organic radicals,
Im is an optionally substituted imidazolidine radical and
An is an anion.

The catalysts of the general formula (C) are known in principle (see, for example, Angew. Chem. Int. Ed. 2004, 43, 6161-6165).

X¹ and X² in the general formula (C) may have the same general, preferred and particularly preferred definitions as in the formulae (A) and (B).

The imidazolidine radical (Im) typically has a structure of the general formula (IIa) or (IIb) which has already been specified for the catalyst type of the formulae (A) and (B) and may also have any of the structures specified there as preferred, especially those of the formulae (IIIa)-(IIIf).

The R″ radicals in the general formula (C) are the same or different and are each a straight-chain or branched C₁-C₃₀-alkyl, C₅-C₃₀-cycloalkyl or aryl radical, where the C₁-C₃₀-alkyl radicals may optionally be interrupted by one or more double or triple bonds or else one or more heteroatoms, preferably oxygen or nitrogen.

Aryl comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The R″ radicals in the general formula (C) are preferably the same and are each phenyl, cyclohexyl, cyclopentyl, isopropyl, o-tolyl, o-xylyl or mesityl.

Alternatively, it is also possible to use a catalyst of the general formula (D) in which

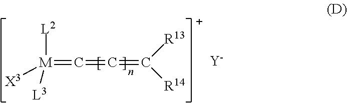

M is ruthenium or osmium,
R¹³, R¹⁴ are each independently hydrogen, C₁-C₂₀-alkyl, C₂-C₂₀-alkenyl, C₂-C₂₀ alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀ alkylsulphinyl,
X³ is an anionic ligand,
L² is an uncharged π-bonded ligand, no matter whether mono- or polycyclic,
L³ is a ligand from the group of the phosphines, sulphonated phosphines, fluorinated phosphines, functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines, stibines, ethers, amines, amides, imines, sulphoxides, thioethers and pyridines,
Y⁻ is a non-coordinating anion and
n is 0, 1, 2, 3, 4 or 5.

In a further embodiment, a catalyst of the general formula (E) is used

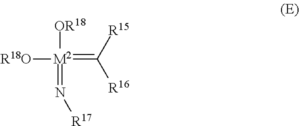

in which
M² is molybdenum,
R¹⁵ and R¹⁶ are the same or different and are each hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀ alkylsulphinyl,
R¹⁷ and R¹⁸ are the same or different and are each a substituted or halogen-substituted C₁-C₂₀-alkyl, C₆-C₂₄-aryl, C₆-C₃₀-aralkyl radical or silicon-containing analogues thereof.

Alternatively, it is also possible to use a catalyst of the general formula (F)

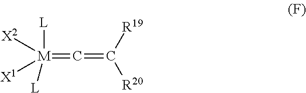

in which
M is ruthenium or osmium,
X¹ and X² are the same or different and are each anionic ligands which may assume all definitions of X¹ and X² given in the general formulae (A) and (B),
L are identical or different ligands which may assume all definitions of L given in the general formulae (A) and (B),
R¹⁹ and R²⁰ are the same or different and are each hydrogen or substituted or unsubstituted alkyl.

Alternatively, it is also possible to use a catalyst of the general formula (G), (H) or (K)

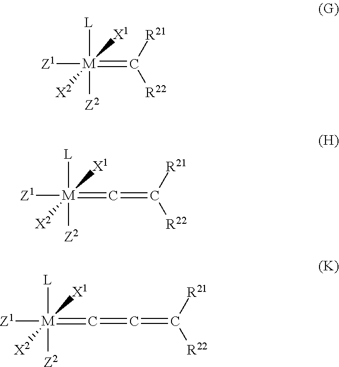

where
M is osmium or ruthenium,
X¹ and X² are the same or different and are two ligands, preferably anionic ligands,
L is a ligand, preferably an uncharged electron donor,
Z¹ and Z² are the same or different and are each uncharged electron donors,
R²¹ and R²² are each independently hydrogen, alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl, each of which is substituted by one or more radicals selected from alkyl, halogen, alkoxy, aryl and heteroaryl.

The catalysts of the general formulae (G), (H) and (K) are known in principle, for example from WO 2003/011455 A1, WO 2003/087167 A2, Organometallics 2001, 20, 5314 and Angew. Chem. Int. Ed. 2002, 41, 4038. The catalysts are commercially available or else can be synthesized by the preparation methods specified in the aforementioned references.

In the catalysts of the general formulae (G), (H) and (K) usable in accordance with the invention, Z¹ and Z² are the same or different and are each uncharged electron donors. These ligands are typically weakly coordinating. They are typically optionally substituted heterocyclic groups. These may be five- or six-membered monocyclic groups having 1 to 4, preferably 1 to 3 and more preferably 1 or 2 heteroatoms or bi- or polycyclic structures composed of 2, 3, 4 or 5 such five- or six-membered monocyclic groups, where each of the aforementioned groups may optionally be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals, each of which may again be substituted by one or more groups, preferably selected from the group consisting of halogen, especially chlorine or bromine, C₁-C₅-alkyl, C₁-C₅-alkoxy and phenyl.

Examples of Z¹ and Z² include nitrogen-containing heterocycles such as pyridines, pyridazines, bipyridines, pyrimidines, pyrazines, pyrazolidines, pyrrolidines, piperazines, indazoles, quinolines, purines, acridines, bisimidazoles, picolylimines, imidazolidines and pyrroles.

Z¹ and Z² may also be bridged to one another to form a cyclic structure. In this case, Z¹ and Z² are a single bidentate ligand.

In the catalysts of the general formulae (G), (H) and (K), L may assume the same general, preferred and particularly preferred definitions as L in the general formulae (A) and (B).

In the catalysts of the general formulae (G), (H) and (K), R²¹ and R²² are the same or different and are each alkyl, preferably C₁-C₃₀-alkyl, more preferably C₁-C₂₀-alkyl, cycloalkyl, preferably C₃-C₂₀-cycloalkyl, more preferably C₃-C₈-cycloalkyl, alkenyl, preferably C₂-C₂₀-alkenyl, more preferably C₂-C₁₆-alkenyl, alkynyl, preferably C₂-C₂₀-alkynyl, more preferably C₂-C₁₆-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where the aforementioned substituents may each be substituted by one or more alkyl, halogen, alkoxy, aryl or heteroaryl radicals.

In the catalysts of the general formulae (G), (H) and (K), X¹ and X² are the same or different and may have the same general, preferred and particularly preferred definitions as specified above for X¹ and X² in the general formula (A).

Preference is given to using catalysts of the general formulae (G), (H) and (K) where
M is ruthenium,
X¹ and X² are both halogen, especially chlorine,
R¹ and R² are the same or different and are each five- or six-membered monocyclic groups having 1 to 4, preferably 1 to 3 and more preferably 1 or 2 heteroatoms or bi- or polycyclic structures composed of 2, 3, 4 or 5 such five- or six-membered monocyclic groups, where each of the aforementioned groups may be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals,
R²¹ and R²² are the same or different and are each C₁-C₃₀-alkyl C₃-C₂₀-cycloalkyl, C₂-C₂₀-alkenyl, C₂-C₂₀-alkynyl, C₆-C₂₄-aryl, C₁-C₂₀-carboxylates, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl, C₁-C₂₀-alkylsulphinyl, and
L has a structure of the general formula (IIa) or (IIb) already described above, especially of the formulae (IIIa) to (IIIf).

A particularly preferred catalyst covered by the general formula (G) has the structure (XIX)

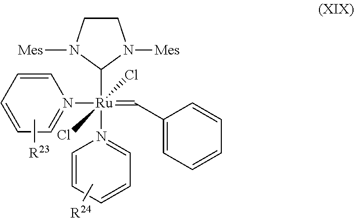

in which
R²³ and R²⁴ are the same or different and are each halogen, straight-chain or branched C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, dialkylamino, trialkylsilyl and trialkoxysilyl.

Said C₁-C₂₀-alkyl, C₁-C₂₀-heteroalkyl, C₁-C₁₀-haloalkyl, C₁-C₁₀-alkoxy, C₆-C₂₄-aryl radicals, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, trialkylsilyl and trialkoxysilyl, may again each be substituted by one or more halogen, preferably fluorine, chlorine or bromine, C₁-C₅-alkyl, C₁-C₅-alkoxy or phenyl radicals.

Particularly preferred embodiments of the catalyst of the formula (XIX) have the structures (XIX a) or (XIX b), where R²³ and R²⁴ are each as defined in the formula (XIX).

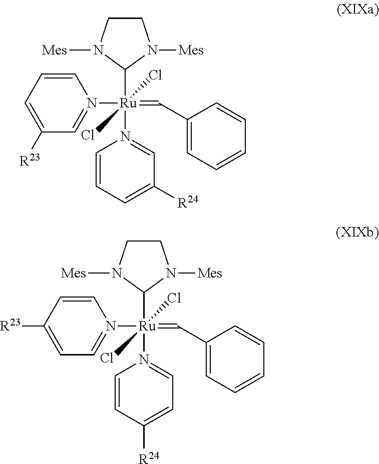

When R²³ and R²⁴ are each H, the literature makes reference to the “Grubbs III catalyst”.

Further suitable catalysts covered by the general formulae (G), (H) and (K) have the structural formulae (XX)-(XXXI) given below, where Mes in each case is 2,4,6-trimethylphenyl.

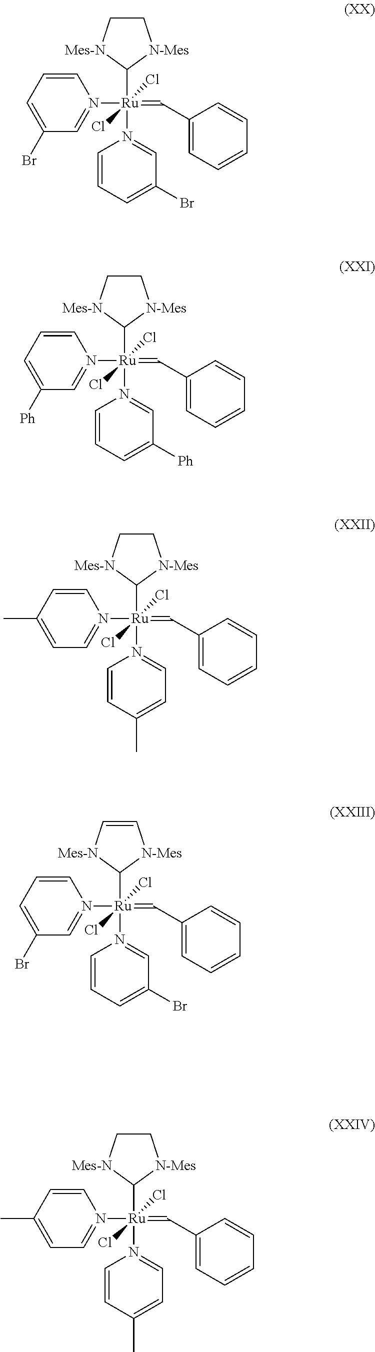

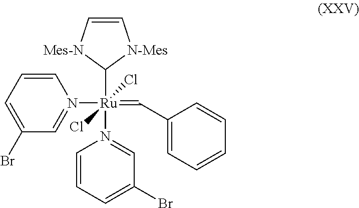

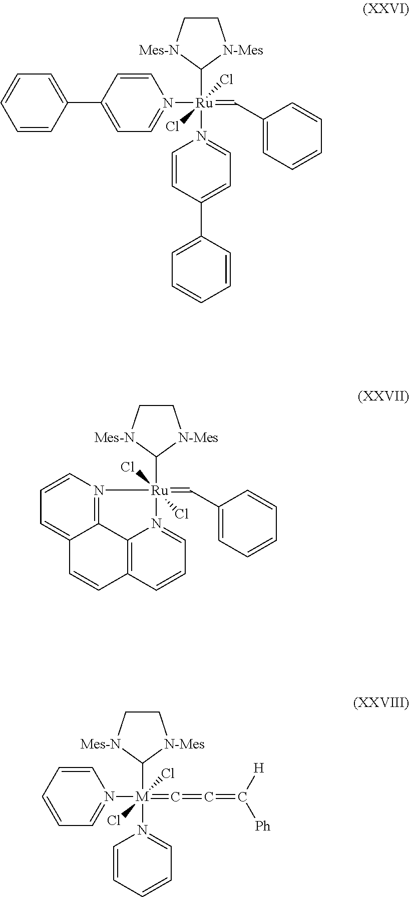

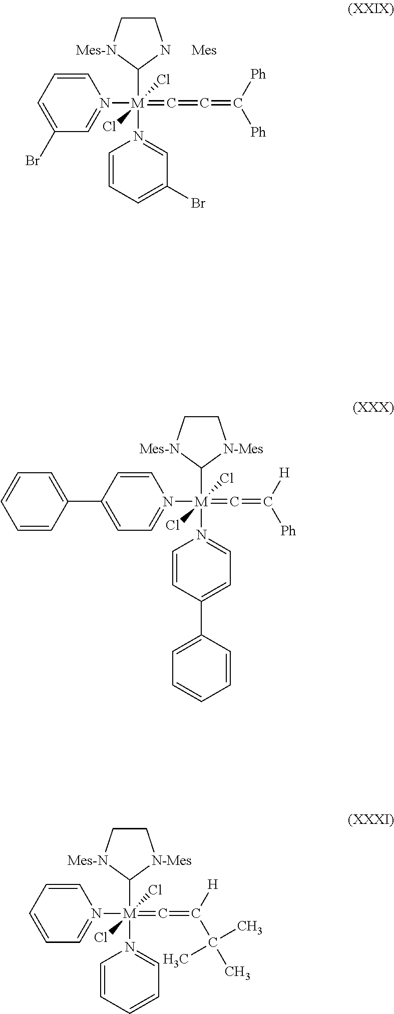

Alternatively, it is also possible to use a catalyst (N) which has the general structural element (N1), where the carbon atom identified by “*” is bonded to the catalyst base skeleton via one or more double bonds,

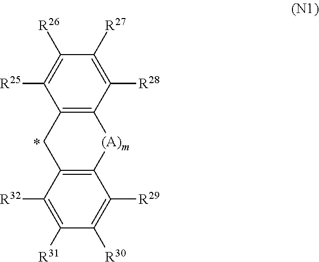

and in which
R²⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻, or are each alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where all these radicals may each optionally be substituted by one or more alkyl, halogen, alkoxy, aryl or heteroaryl radicals, or alternatively two directly adjacent radicals in each case from the group of R²⁵-R³², including the ring carbon atoms to which they are bonded, are bridged to form a cyclic group, preferably an aromatic system, or alternatively R⁸ is optionally bridged with another ligand of the ruthenium- or osmium-carbene complex catalyst,
m is 0 or 1 and
A is oxygen, sulphur, C(R³³R³⁴), N—R³⁵, —C(R³⁶)═C(R³⁷)—, —C(R³⁶)(R³⁸)—C(R³⁷)(R³⁹)—, in which R³³-R³⁹ are the same or different and may each have the same definitions as the R²⁵-R³² radicals.

The inventive catalysts have the structural element of the general formula (N1), where the carbon atom identified by “*” is bonded to the catalyst base skeleton via one or more double bonds. When the carbon atom identified by “*” is bonded to the catalyst base skeleton via one or more double bonds, these double bonds may be cumulated or conjugated.

Such catalysts (N) are already described in EP-A-2 027 920, which is hereby incorporated by reference for the definition of the catalysts (N) and preparation thereof, where this is permitted by the particular jurisdictions.

The catalysts (N) with a structural element of the general formula (N1) include, for example, those of the following general formulae (N2a) and (N2b)

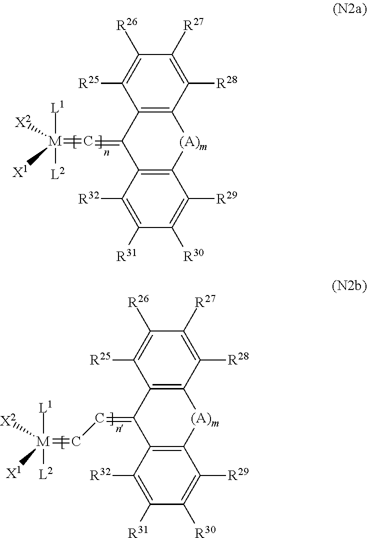

in which
M is ruthenium or osmium,
X¹ and X² are the same or different and are two ligands, preferably anionic ligands,
L¹ and L² are identical or different ligands, preferably uncharged electron donors, where L² may alternatively also be bridged to the R⁸ radical,
n is 0, 1, 2 or 3, preferably 0, 1 or 2,
n′ is 1 or 2, preferably 1, and
R²⁵-R³², m and A each have the same definitions as in the general formula (N1).

In the catalysts of the general formula (N2a), the structural element of the general formula (N1) is bonded to the central metal of the complex catalyst via a double bond (n=0) or via 2, 3 or 4 cumulated double bonds (in the case that n=1, 2 or 3). In the inventive catalysts of the general formula (N2b), the structural element of the general formula (N1) is bonded to the metal of the complex catalyst via conjugated double bonds. In both cases, there is a double bond in the direction of the central metal of the complex catalyst on the carbon atom identified by “*”.

The catalysts of the general formula (N2a) and (N2b) thus include catalysts in which the following general structural elements (N3)-(N9)

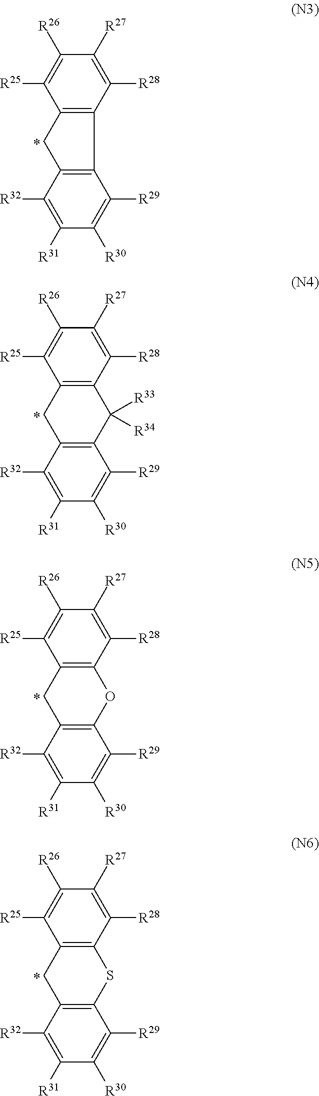

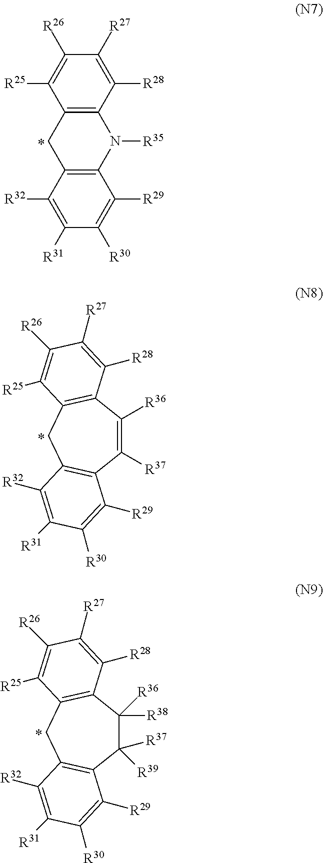

are bonded via the carbon atom identified by “*”, via one or more double bonds, to the catalyst base skeleton of the general formula (N10a) or (N10b)

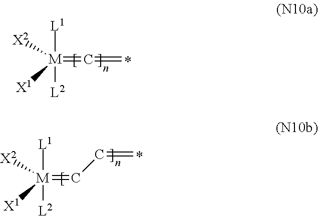

where X¹ and X², L¹ and L², n, n and R²⁵-R³⁹ are each as defined for the general formulae (N2a) and (N2b).

Typically, the inventive ruthenium- or osmium-carbene catalysts are pentacoordinated.

In the structural element of the general formula (N1), R¹⁵-R³²
are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻, or are each alkyl, preferably C₁-C₂₀-alkyl, especially C₁-C₆-alkyl, cycloalkyl, preferably C₃-C₂₀-cycloalkyl, especially C₃-C₈-cycloalkyl, alkenyl, preferably C₂-C₂₀-alkenyl, alkynyl, preferably C₂-C₂₀-alkynyl, aryl, preferably C₆-C₂₄-aryl, especially phenyl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, alkylsulphinyl, preferably C₁-C₂₀-alkylsulphinyl, dialkylamino-, preferably di(C₁-C₂₀-alkyl)amino, alkylsilyl, preferably C₁-C₂₀-alkylsilyl, or alkoxysilyl, preferably C₁-C₂₀-alkoxysilyl radicals, where all these radicals may each optionally be substituted by one or more alkyl, halogen, alkoxy, aryl or heteroaryl radicals, or alternatively two directly adjacent radicals in each case from the group of R²⁵-R³², including the ring carbon atoms to which they are bonded, may also be bridged to form a cyclic group, preferably an aromatic system, or alternatively R⁸ is optionally bridged with another ligand of the ruthenium- or osmium-carbene complex catalyst,
m is 0 or 1 and
A is oxygen, sulphur, C(R³³)(R³⁴), N—R³⁵, —C(R³⁶)═C(R³⁷)— or —C(R³⁶)(R³⁸)—C(R³⁷)(R³⁹)—, in which R³³-R³⁹ are the same or different and may each have the same preferred definitions as the R¹-R⁸ radicals.

C₁-C₆-Alkyl in the structural element of the general formula (N1) is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl in the structural element of the general formula (N1) is, for example, cyclopropyl, cyclobutyl, cyclopentyl, cyclohexyl, cycloheptyl and cyclooctyl.

C₆-C₂₄-Aryl in the structural element of the general formula (N1) comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The X¹ and X² radicals in the structural element of the general formula (N1) have the same general, preferred and particularly preferred definitions which are specified for catalysts of the general formula A.

In the general formulae (N2a) and (N2b) and analogously in the general formulae (N10a) and (N10b), the L¹ and L² radicals are identical or different ligands, preferably uncharged electron donors and may have the same general, preferred and particularly preferred definitions which are specified for catalysts of the general formula A.

Preference is given to catalysts of the general formula (N2a) or (N2b) with a general structural unit (N1) where
M is ruthenium,
X¹ and X² are both halogen,
n is 0, 1 or 2 in the general formula (N2a) or
n′ is 1 in the general formula (N2b)
L¹ and L² are the same or different and have the general or preferred definitions specified for the general formulae (N2a) and (N2b),
R²⁵-R³² are the same or different and have the general or preferred definitions specified for the general formulae (N2a) and (N2b),
m is either 0 or 1,
   and, when m=1,
A is oxygen, sulphur, C(C₁-C₁₀-alkyl)₂, —C(C₁-C₁₀-alkyl)₂-C(C₁-C₁₀-alkyl)₂-, —C(C₁-C₁₀-alkyl)=C(C₁-C₁₀-alkyl)- or —N(C₁-C₁₀-alkyl).

Particular preference is given to catalysts of the formula (N2a) or (N2b) with a general structural unit (N1) where
M is ruthenium,
X¹ and X² are both chlorine,
n is 0, 1 or 2 in the general formula (N2a) or
n′ is 1 in the general formula (N2b)
L¹ is an imidazolidine radical of the formulae (IIIa) to (IIIf),
L² is a sulphonated phosphine, phosphate, phosphinite, phosphonite, arsine, stibine, ether, amine, amide, sulphoxide, carboxyl, nitrosyl, pyridine radical, an imidazolidine radical of the formulae (XIIa) to (XIIf) or a phosphine ligand, especially PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃,
R²⁵-R³² have the general or preferred definitions specified for the general formulae (N2a) and (N2b),
m is either 0 or 1,
   and, when m=1,
A is oxygen, sulphur, C(C₁-C₁₀-alkyl)₂, —C(C₁-C₁₀-alkyl)₂-C(C₁-C₁₀-alkyl)₂-, —C(C₁-C₁₀-alkyl)=C(C₁-C₁₀-alkyl)- or —N(C₁-C₁₀-alkyl).

In the case that the R²³ radical is bridged with another ligand of the catalyst of the formula N, for example for the catalysts of the general formulae (N2a) and (N2b), this gives rise to the following structures of the general formulae (N13a) and (N13b)

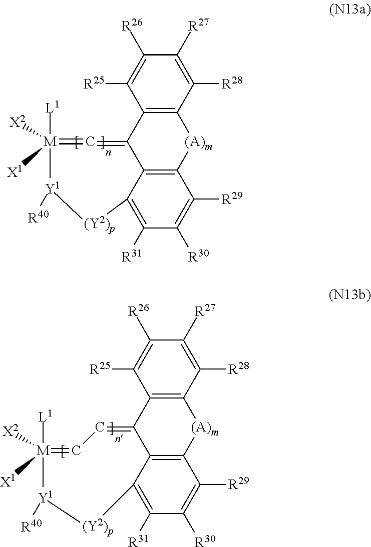

in which
Y¹ is oxygen, sulphur, an N—R⁴¹ radical or a P—R⁴¹ radical, where R⁴¹ is as defined below,
R⁴⁰ and R⁴¹ are the same or different and are each an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
p is 0 or 1 and
Y² when p=1 is —(CH₂)ᵣ— where r=1, 2 or 3, —C(═O)—CH₂—, —C(═O)—, —N═CH—, —N(H)—C(═O)—, or else alternatively the overall structural unit “—Y¹(R⁴⁰)—(Y²)ₚ—” is (—N(R⁴⁰)═CH—CH₂—), (—N(R⁴⁰,R⁴¹)═CH—CH₂—), and
   where M, X¹, X², L¹, R²⁵-R³², A, m and n have the same definitions as in the general formulae (IIa) and (IIb).

Examples of catalysts of the formula (N) include the following structures:

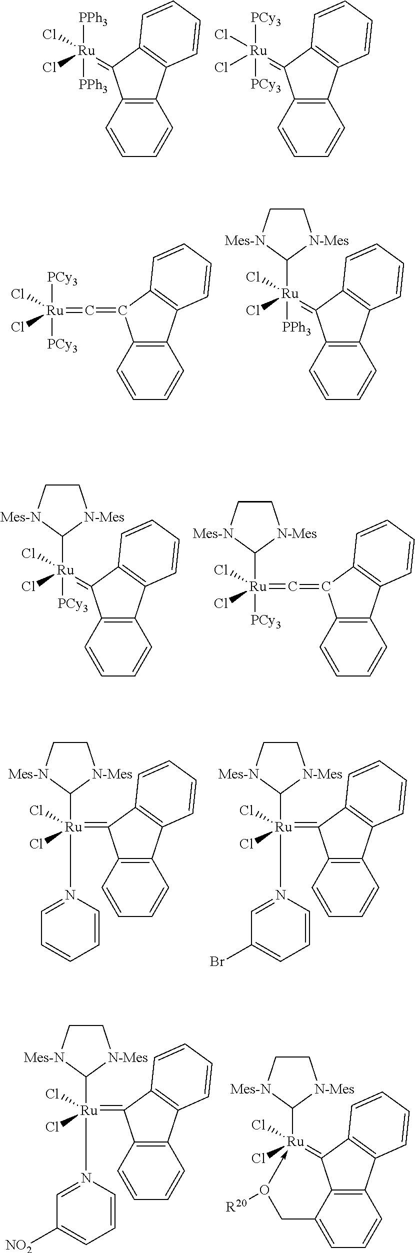

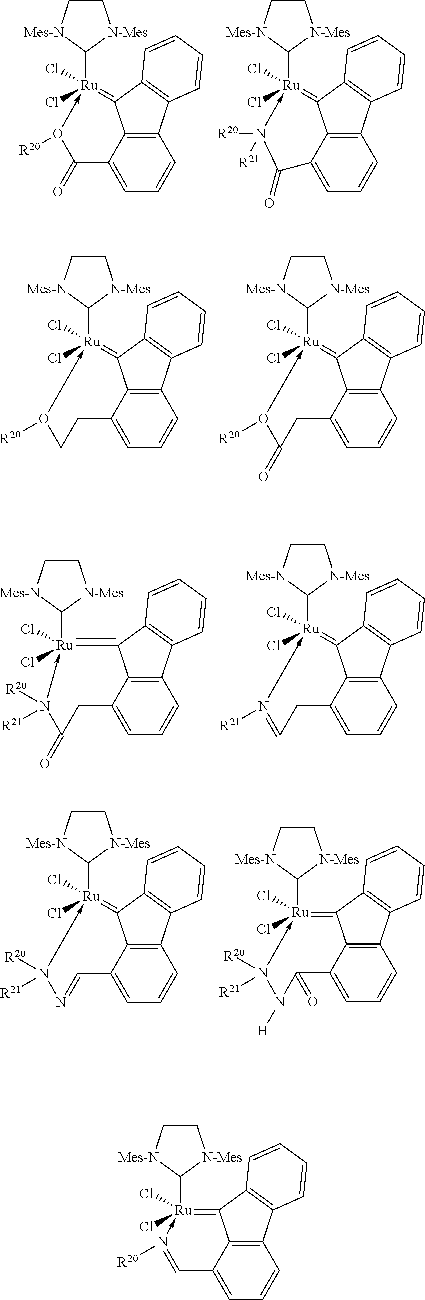

### Performance of the Process According to the Invention:

To produce the inventive blends, at least one partly hydrogenated nitrile rubber and at least one silicone rubber containing vinyl groups are mixed in the presence of a metathesis catalyst, said metathesis catalyst being a complex catalyst which is based on a metal of transition group 6 or 8 of the Periodic Table and has at least one ligand bound in a carbene-like manner to the metal.

This process is preferably performed essentially without solvent, i.e. essentially no solvent is added in the course of mixing. This form of performance is customarily also referred to in the specialist field as performance “in bulk”.

The amount of the complex catalyst based on the sum of the partly hydrogenated nitrile rubber and silicone rubber containing vinyl groups used depends on the nature and catalytic activity of the specific complex catalyst. The amount of complex catalyst used is typically 1 to 1000 ppm of noble metal, preferably 2 to 500 ppm, especially 5 to 250 ppm, based on the total amount of rubber, i.e. the sum of partly hydrogenated nitrile rubber and silicone rubber containing vinyl groups used.

The partly hydrogenated nitrile rubber and the silicone rubber containing vinyl groups can be used in a weight ratio of 5:95 to 95:5, preferably of 10:90 to 90:10. Preference is given to using 10 to 45 parts by weight of partly hydrogenated nitrile rubber and 55 to 90 parts by weight of the silicone rubber containing vinyl groups. Preference is equally given to using 55 to 90 parts by weight of partly hydrogenated nitrile rubber and 10-45 parts by weight of the silicone rubber containing vinyl groups. Particular reference is given to using 10-30 parts by weight of the partly hydrogenated nitrile rubber and 70 to 90 parts by weight of the silicone rubber containing vinyl groups. Particular preference is equally given to using 70 to 90 parts by weight of partly hydrogenated nitrile rubber and 10-30 parts by weight of the silicone rubber containing vinyl groups.

For conversion of the at least one partly hydrogenated nitrile rubber and at least one silicone rubber containing vinyl groups in the presence of a metathesis catalyst, the three components are mixed, which can be done batchwise or else continuously using mixing units. Such mixing units are known. For a batchwise mode of mixing, for example, a Brabender mixer or a roll mill are suitable. For continuous mixture production, twin-shaft screw systems are especially suitable. In the case of batchwise mixture production, it has been found to be useful to initially charge the partly hydrogenated nitrile rubber in the mixer, to knead it for a certain time for example 0.5 to 5 minutes at a temperature of 10 to 80° C., preferably 20 to 50° C., and then to add the silicone rubber containing vinyl groups and the metathesis catalyst and to mix the resulting mixture at 20 to 120° C., preferably 20 to 100° C. It is possible to perform the production of the rubber blend in a single mixing stage, but it is also possible to perform several mixing stages in succession, in which case the metathesis catalyst is also added in distribution over the mixing stages in appropriate proportions. The temperatures specified above can be established by the person skilled in the art in each case by suitable choice of rotor speed, ram pressure and jacket heating (internal mixer) or by friction and heating or cooling (roller system). It is also possible to store the unvulcanized rubber blends between the individual mixing stages, for example for up to 3 days.

The duration of the mixing operation and hence the metathesis reaction depends on a series of factors, for example on the type of the partly hydrogenated NBR and of the silicone rubber containing vinyl groups, the metathesis catalyst, the catalyst concentration and the reaction temperature. The progress of the metathesis can be monitored by standard analysis, for example by GPC measurements or by determining the viscosity. Alternatively, the use of imaging processes is also possible, for example the production of SEM images.

The invention further provides vulcanizable mixtures comprising
(i) at least one rubber blend obtainable by mixing at least one partly hydrogenated nitrile rubber and at least one silicone rubbers containing vinyl groups in the presence of a metathesis catalyst which is a complex catalyst which is based on a metal of transition group 6 or 8 of the Periodic Table and has at least one ligand bound in a carbene-like manner to the metal, and
(ii) at least one peroxidic crosslinking system.

In addition, the vulcanizable mixtures may also comprise one or more further customary additives.

These vulcanizable mixtures are typically produced by mixing the rubber blend (i) which has already been produced beforehand with at least one peroxidic crosslinking system (ii) and optionally the further additives.

In the peroxidic crosslinking system, the peroxidic crosslinker used may, for example, be bis(2,4-dichlorobenzyl)peroxide, dibenzoyl peroxide, bis(4-chlorobenzoyl)peroxide, 1,1-bis(t-butyl peroxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)-3-hexyne.

In the peroxidic crosslinking system, it may be advantageous to use, as well as the peroxidic crosslinkers, also further additions which can help to increase the crosslinking yield: Suitable examples thereof include triallyl isocyanurate, triallyl cyanurate, trimethylolpropane tri(meth)acrylate, triallyltrimellitate, ethylene glycol dimethacrylate, butanediol dimethacrylate, trimethylolpropane trimethacrylate, zinc diacrylate, zinc dimethacrylate, 1,2-polybutadiene or N,N′-m-phenylenedimaleimide.

The total amount of the peroxidic crosslinking systems is typically in the range from 0.1 to 100 parts by weight, preferably in the range from 0.5 to 75 parts by weight and more preferably in the range from 1 to 50 parts by weight, based on 100 parts by weight of the sum of partly hydrogenated nitrile rubber and silicone rubber containing vinyl groups. The amount of peroxidic crosslinker, i.e. active substance, is typically in the range from 0.5 to 15 parts by weight, preferably in the range from 1 to 12.5 parts by weight and more preferably in the range from 1.5 to 10 parts by weight, based on 100 parts by weight of the sum of partly hydrogenated nitrile rubber and silicone rubber containing vinyl groups.

As well as the addition of the peroxidic crosslinking system, the vulcanizable mixture may also comprise further customary rubber additives.

These include, for example, the typical substances well known to those skilled in the art, such as fillers, filler activators, scorch retardants, antiozonants, ageing stabilizers, antioxidants, processing aids, extender oils, plasticizers, reinforcing materials and mould release agents.

The fillers used may, for example, be carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form), or silicates.

Useful filler activators include organic silanes in particular, for example vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler activators are, for example, interface-active substances such as triethanolamine and ethylene glycols with molecular weights of 74 to 10 000 g/mol. The amount of filler activators is typically 0 to 10 phr, based on the amount of the filler. The determination of the suitable amount of filler activator is familiar to the person skilled in the art, as a function of the type and amount of the filler.

In addition, it is also possible to use scorch retardants. These include, for example, compounds as specified in WO-A-97/01597 and U.S. Pat. No. 4,857,571. Preference is given to sterically hindered p-dialkylaminophenols, especially Ethanox 703 (Sartomer).

The ageing stabilizers added to the vulcanizable mixtures may, for example, be the following: polymerized 2,2,4-trimethyl-1,2-dihydroquinoline (TMQ), 2-mercaptobenzimidazole (MBI), methyl-2-mercaptobenzimidazole (MMBI) or zinc methylmercaptobenzimidazole (ZMMBI).

Alternatively, it is also possible to use the following, though less preferred, ageing stabilizers: aminic ageing stabilizers, for example in the form of mixtures of diaryl-p-phenylenediamines (DTPD), octylated diphenylamine (ODPA), phenyl-α-naphthylamine (PAN) and/or phenyl-β-naphthylamine (PBN). Preference is given to using those based on phenylenediamine. Examples of phenylenediamines are N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD) and N,N′-bis-1,4-(1,4-dimethylpentyl)-p-phenylenediamine (7PPD).

The ageing stabilizers are typically used in amounts of up to 10 parts by weight, preferably up to 5 parts by weight, more preferably 0.25 to 3 parts by weight, especially 0.4 to 1.5 parts by weight, based on 100 parts by weight of the sum of partly hydrogenated nitrile rubber and silicone rubber containing vinyl groups.

Examples of useful mould release agents include: saturated and partly unsaturated fatty acids and oleic acids and derivatives thereof (fatty acid esters, fatty acid salts, fatty alcohols, fatty acid amides), which are preferably used as a mixture constituent, and also products applicable to the mould surface, for example products based on low molecular weight silicone compounds, products based on fluoropolymers and products based on phenol resins.

The mould release agents are typically used in amounts of approx. 0 to 10 parts by weight, preferably 0.5 to 5 parts by weight, based on 100 parts by weight of the sum of partly hydrogenated nitrile rubber and silicone rubber containing vinyl groups.

Another possibility is reinforcement with strengthening agents (fibres) made of glass, according to the teaching of U.S. Pat. No. 4,826,721, and another is reinforcement by cords, woven fabrics, fibres made of aliphatic and aromatic polyamides (Nylon®, Aramid®), polyesters and natural fibre products.

The invention further provides a process for producing vulcanizates based on at least one inventive rubber blend, which is characterized in that the above-described vulcanizable mixture is crosslinked by increasing the temperature, preferably in a shaping process, more preferably using injection moulding.

The invention thus likewise provides the vulcanizate, preferably in the form of a moulding, obtainable by the aforementioned vulcanization process.

This vulcanization process makes it possible to produce a multitude of mouldings, for example a seal, a cap, a hose or a membrane. More particularly, it is possible to produce O ring seals, flat seals, corrugated gaskets, sealing sleeves, sealing caps, dust protection caps, plug seals, thermal insulation hoses, oil cooler hoses, air intake hoses, servocontrol hoses or pump diaphragms.

### EXAMPLES

In the examples which follow, blends of different composition based on partly hydrogenated nitrile rubber (Therban® 3467), abbreviated hereinafter to “HNBR”, and silicone rubber containing vinyl groups (Silopren® VR), abbreviated hereinafter to “VMQ”, were produced. The unvulcanized rubber blends were analysed by means of scanning electron microscopy and by means of gel permeation chromatography. The unvulcanized rubber blends were subsequently mixed with a peroxidic crosslinker and various additives, and vulcanized. The vulcanizates were characterized by different methods.

### (A) Production of Unvulcanized Rubber Blends

The composition of the unvulcanized rubber blends is summarized in Table 1. The noninventive examples are each identified by “CC”.

TABLE 1
Compositions

| | | Example | | | | | | | |
|---|---|---|---|---|---|---|---|---|---|
| | | 1.1 | 1.2 | | 1.4 | | 1.6 | | 1.8 |
| | | CC | CC | 1.3 | CC | 1.5 | CC | 1.7 | CC |
| Therban ® | parts | 100 | 90 | 90 | 80 | 80 | 100 | 90 | 100 |
| 3467 ¹⁾ | by | | | | | | | | |
| | wt. | | | | | | | | |
| Siloprene ® | parts | — | 10 | 10 | 20 | 20 | — | 10 | — |
| VR ²⁾ | by | | | | | | | | |
| | wt. | | | | | | | | |
| Catalyst ³⁾: | | | | | | | | | |
| 1st mixing | parts | — | — | 0.1 | — | 0.1 | — | 0.1 | — |
| stage | by | | | | | | | | |
| | wt. | | | | | | | | |
| 2nd mixing | parts | — | — | — | — | 0.1 | — | 0.1 | — |
| stage | by | | | | | | | | |
| | wt. | | | | | | | | |
| 3rd mixing | parts | — | — | — | — | 0.1 | — | 0.1 | — |
| stage | by | | | | | | | | |
| | wt. | | | | | | | | |

¹⁾ Therban ® 3467: partly hydrogenated nitrile rubber; acrylonitrile content: 34% by weight; residual double bond content: 5.5%; Mooney viscosity [ML(1 + 4) at 100° C.]: 68 ME (commercial product from Lanxess Deutschland GmbH)
²⁾ Siloprene ® VR: polydimethylsilicone rubber with 5 mol % of vinyl groups (commercial product from Momentive Performance Materials), a number-average molecular weight Mn of 138 000 g/mol and a weight-average Mw of 304 000 g/mol.
³⁾ Catalyst: (1,3-bis(2,4,6-trimethylphenyl)-2-imidazolidinylidene)dichloro(o-
isopropoxyphenylmethylene)ruthenium (Grubbs-Hoveyda catalyst from Sigma-Aldrich)

In the production of inventive blends 1.3, 1.5 and 1.7, the “Grubbs-Hoveyda catalyst” of the following formula was used. The noninventive blends 1.2 CC, 1.4 CC, 1.6 CC and 1.8 CC were produced without using metathesis catalyst. In the production of Inventive Example 1.3, the metathesis catalyst was added in the 1st mixing stage. In Inventive Examples 1.5 and 1.7, the catalyst was added in three mixing stages.

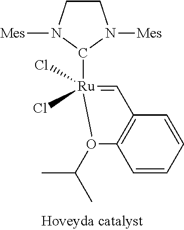

The HNBR/VMQ blends of Examples 1.2-1.5 and 1.7 were produced in an MIM Brabender with a capacity of 350 ml at a fill level of 70% and a rotor speed of 50 min⁻¹. The blends were produced by in each case adding Therban® 3467 to the Brabender and kneading at a start temperature of 35° C. for 2 min. Thereafter, Siloprene® VR and, in the inventive examples, also metathesis catalyst were added gradually to the Brabender within 5 min. Thereafter, the mixtures were kneaded for 60 min, in the course of which the internal temperature was kept at 60° C. by adjusting the rotor speed and the ram pressure. In Example 1.3, the metathesis catalyst was added in the 1st mixing stage. In Examples 1.5 and 1.7, in addition to the 1st mixing stage, a 2nd and a 3rd mixing stage were conducted, and the blends were stored at room temperature for 24 h between each of the mixing stages. The 2nd and 3rd mixing stages were conducted in an identical manner to the 1st mixing stage (in each case at 60° C. for 60 min).

### Determination of the Phase Morphology by Scanning Electron Microscopy:

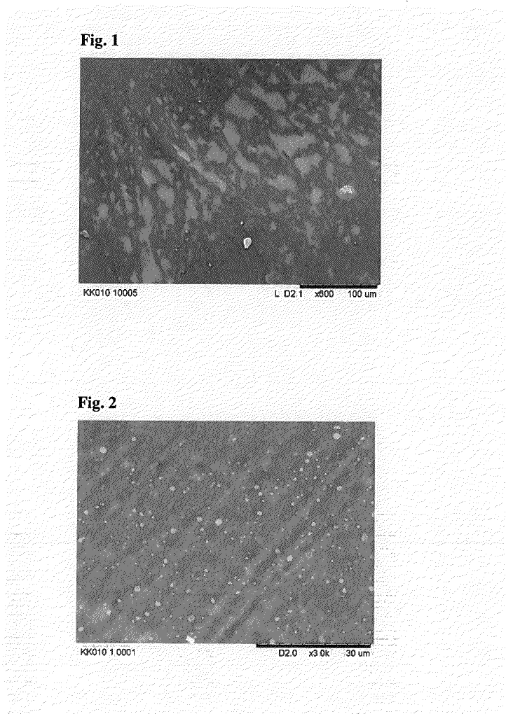

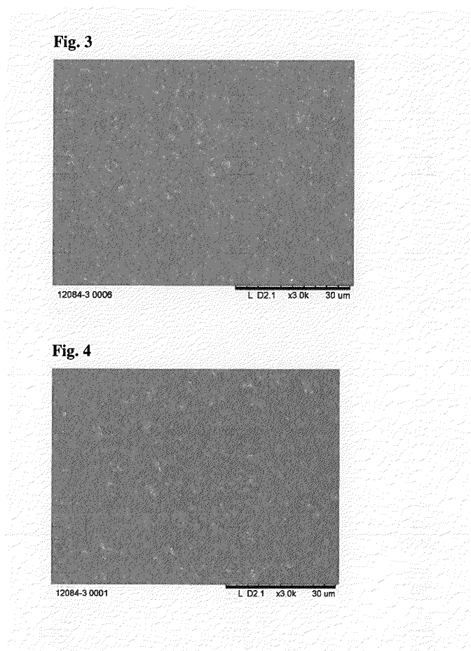

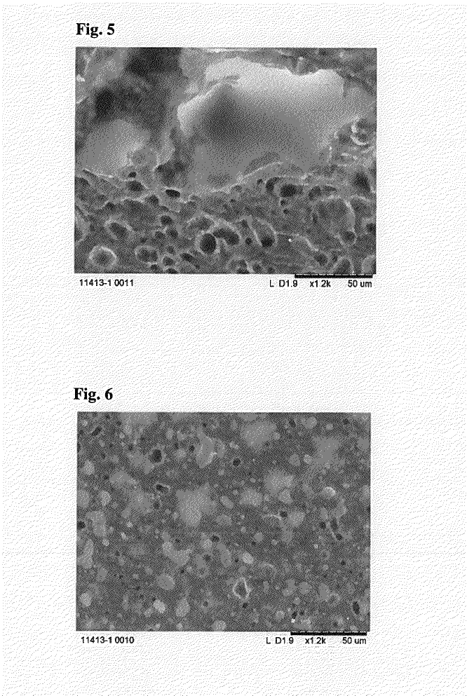

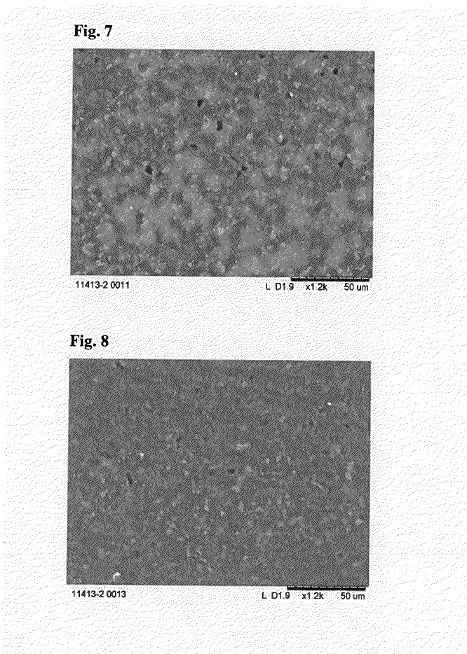

To assess the phase morphology of the unvulcanized HNBR/VMQ blends, scanning electron microscopy (“SEM”) studies were conducted. For this purpose, unvulcanized HNBR/VMQ blends with 10% by weight of VMQ (Examples 1.2 CC and 1.7) and with 20% by weight of VMQ (Examples 1.4 CC and 1.5) were selected. For the SEM studies, samples of thickness approx. 1 mm without unevenness were prepared from the blends by means of a scalpel. The SEM studies were conducted without prior vapour deposition of a metal film. To reduce the electrostatic charging of the samples during the SEM studies, the “Charge-up Reduction Mode” was selected. The microscope used was a Hitachi TM-1000 tabletop microscope.
FIG. 1 and FIG. 2: SEM images of the rubber blend from Example 1.2 CC (FIG. 1: 600-fold magnification, FIG. 2: 3000-fold magnification)
FIG. 3 and FIG. 4: SEM images of the rubber blend from Example 1.7 (FIG. 3: 3000-fold magnification, FIG. 4: 3000-fold magnification)
FIG. 5 and FIG. 6: SEM images of the rubber blend from Example 1.4 CC (FIG. 5: 1200-fold magnification, FIG. 6: 1200-fold magnification)
FIG. 7 and FIG. 8: SEM images of the rubber blend from Example 1.5 (FIG. 7: 1200-fold magnification, FIG. 8: 1200-fold magnification)

The light areas in the SEM images are VMQ particles dispersed in HNBR as the continuous phase (recognizable as dark areas).

The size of the VMQ particles is a measure of the compatibility of the polymers. The higher the miscibility of the two polymers, the smaller the separate phases, since interfacial tension decreases with rising miscibility. The comparison of the SEM images of HNBR/VMQ blends with in each case 10% by weight of VMQ (Example 1.2 CC and Inventive Example 1.7), and analogously with in each case 20% by weight of VMQ (Example 1.4 CC and Inventive Example 1.5), shows that the use of the metathesis catalyst distinctly reduces the size of the separate VMQ particles. This is indirect evidence for the formation of graft copolymers from the partly hydrogenated nitrile rubbers.

### Molar Masses:

The molar masses of the unvulcanized HNBR/VMQ blends and of the pure HNBR and VMQ blend components were determined by means of gel permeation chromatography (GPC). For this purpose, approx. 15 mg of each sample were dissolved in 3 ml of chloroform at room temperature. After filtration by means of a syringe filter (manufacturer: Macherey-Nagel), the samples were analysed under the following conditions:
Pump: model 510, Waters
Column: PLgel precolumn+Plgel 5 μm MIXED-C 300×7.5 mm PLgel 5 μm MIXED-C 600×7.5 mm, Polymer Laboratories
RI detector: model 410 differential refractometer, Waters
Flow rate: 1.0 ml·ml⁻¹
Temperature: room temperature
Eluent: chloroform (7.5 mmol·l⁻¹ 3-methyl-2-butene)
Calibration standards: polystyrene, Polymer Standard Service molar masses of 1100 to 2.06·10⁶ g/mol.

This gave the results summarized in Table 2.

TABLE 2
Molar masses and polydispersity index (PDI)
of the unvulcanized HNBR/VMQ blends

| Example | 1.2 CC | 1.3 | 1.4 CC | 1.5 | 1.7 | VMQ | HNBR |
|---|---|---|---|---|---|---|---|
| Mn [kg/mol] | 78 | 2092/83 | 65 | 1702/43 | 1368/49 | 138 | 76 |
| Mw [kg/mol] | 224 | 2735/153 | 167 | 2256/81 | 1595/123 | 304 | 254 |
| PDI | 2.88 | 1.31/1.85 | 2.56 | 1.33/1.90 | 1.17/2.50 | 2.20 | 3.34 |

Mₙ represents the number average, M_{w} the weight average and PDI the polydispersity index (PDI = M_{w}/Mₙ); the PDI is a measure of the breadth of the molecular weight distribution,

It has been found that the HNBR/VMQ blends 1.3, 1.5 and 1.7 produced in accordance with the invention, in contrast to the noninventive blends 1.2 and 1.4, have a bimodal distribution of the molar masses, the additional peak for the inventive blends having a high molar mass. This additional peak, however, is less pronounced than the second peak at lower molar mass. It is isolated in Examples 1.3 and 1.5 and is detected as a “shoulder” in Example 1.7. The high molecular weight peak does not occur in either of the pure HNBR and MVQ blend components and is interpreted as HNBR/VMQ graft copolymer.

### (B) Production of Unvulcanized Rubber Mixtures

The rubbers or rubber blends described in Table 1 were used to produce vulcanizable rubber mixtures on a laboratory roll system (roll diameter: 150 mm; roll length: 250 mm, from Troester) at a cooling water temperature of 20° C., and these were then vulcanized. The rubber mixtures had the compositions specified in Table 3.

TABLE 3
Composition of the rubber mixtures

| | Amount |
|---|---|
| Mixture constituent | [parts by wt.] |
| Rubbers or rubber blends from Table 1 | 100 |
| Carbon black ⁴⁾ | 50 |
| 4,4-Bis(1,1-dimethylbenzyl)diphenylamine ⁵⁾ | 1 |
| Zinc salt of methyl-2-mercaptobenzimidazole ⁶⁾ | 0.4 |
| Magnesium oxide ⁷⁾ | 2 |
| Trimellitic esters of linear C₈-C₁₀ alcohols ⁸⁾ | 5 |
| Triallyl isocyanurate ⁹⁾ | 2.1 |
| Di(tert-butylperoxyisopropyl)benzene (40%) ¹⁰⁾ | 7 |

⁴⁾ Corax ® N550 (commercial product from Evonik - Degussa GmbH)
⁵⁾ Luvomax ® CDPA (commercial product from Lehmann & Voss & Co.)
⁶⁾ Vulkanox ® ZMB2/C5 (commercial product from Lanxess Deutschland GmbH)
⁷⁾ Maglite DE (commercial product from Merck & Co. Inc. USA)
⁸⁾ Diplast ® TM 8-10/ST (commercial product from Lonza SpA)
⁹⁾ TAIC - 70 (commercial product from Kettlitz Chemie GmbH & Co.)
¹⁰⁾ Perkadox ® 14-40 (40% supported on pale-coloured filler) (commercial product from Akzo Nobel Chemicals GmbH)

The rubber mixtures were produced in an MINI Brabender of capacity 350 ml at a rotation speed of 50 min⁻¹ and a start temperature of 35° C. The various mixture constituents were added in the sequence specified in Table 3.

### (C) Vulcanization Characteristics of the Rubber Mixtures

The vulcanization characteristics of the rubber mixtures were determined at 180° C. in a Monsanto disk rheometer (MDR) to DIN 53 529, Part 3 (1°, 1.7 Hz).

Definitions to DIN 53 529, Part 3 are:
Fₘᵢₙ: minimum torque of the crosslinking isotherm
Fₘₐₓ: maximum torque of the crosslinking isotherm
Fₘₐₓ−Fₘᵢₙ: difference in the vulcameter readings between maximum and minimum
t₁₀: time at which 10% of Fₘₐₓ−Fₘᵢₙ has been attained
t₅₀: time at which 50% of Fₘₐₓ−Fₘᵢₙ has been attained
t₉₀: time at which 90% of Fₘₐₓ−Fₘᵢₙ has been attained
t₉₅: time at which 95% of Fₘₐₓ−Fₘᵢₙ has been attained

Characteristic parameters for characterization of the vulcanization characteristics of the rubber mixtures are summarized in Table 4.

TABLE 4
Vulcanization characteristics of the rubber mixtures

| | Example | | | | | | | |
|---|---|---|---|---|---|---|---|---|
| | 1.1 | 1.2 | | 1.4 | | 1.6 | | 1.8 |
| | CC | CC | 1.3 | CC | 1.5 | CC | 1.7 | CC |
| Fₘᵢₙ [dNm] | 1.9 | 1.4 | 2.0 | 1.1 | 2.0 | 1.8 | 2.0 | 1.7 |
| Fₘₐₓ [dNm] | 28.5 | 31.7 | 32.0 | 31.2 | 31.4 | 26.9 | 27.8 | 27.2 |
| Fₘₐₓ − Fₘᵢₙ | 26.6 | 30.3 | 30.0 | 30.1 | 29.3 | 25.1 | 25.8 | 25.4 |
| [dNm] | | | | | | | | |
| t₁₀ [sec] | 35 | 36 | 36 | 36 | 42 | 36 | 44 | 37 |
| t₅₀ [sec] | 108 | 113 | 111 | 113 | 125 | 111 | 131 | 115 |
| t₉₀ [sec] | 316 | 352 | 318 | 323 | 344 | 323 | 368 | 339 |
| t₉₅ [sec] | 409 | 470 | 410 | 416 | 442 | 417 | 479 | 438 |
| t₉₀ − t₁₀[sec] | 281 | 316 | 282 | 287 | 302 | 287 | 324 | 302 |

Inventive Examples 1.3, 1.5 and 1.7, compared to the corresponding comparative examples, have equally good or even much longer scorch times (t₁₀) (comparison of 1.3 with 1.1 CC and 1.2 CC; comparison of 1.5 with 1.4 CC and 1.6 CC and comparison of 1.7 with 1.8 CC). This is an indication of comparable or improved processing reliability of the rubber mixtures produced in accordance with the invention.

### (D) Determination of the Properties of the Rubber Vulcanizates

To determine the vulcanizate properties, the rubber mixtures were used to produce test specimens which were vulcanized in a press at 120 bar at 180° C. for 15 min. The vulcanizates were used to determine the properties summarized in Tables 5-7.

### (D1) Determination of the Mechanical Properties

Table 5 compiles mechanical properties which were determined at 23° C. and 70° C. to the following standards:
DIN 53505: Shore A hardness at 23° C. and 70° C.
DIN 53504: Stress values at 10%, 25%, 50%, 100%, 200% and 300% strain (σ₁₀, σ₂₅, σ₅₀, σ₁₀₀, σ₂₀₀ and σ₃₀₀), tensile strength (TS) and breaking strain (ε_{b}) at 23° C. and 70° C.

TABLE 5
Mechanical properties of the vulcanized rubber mixtures

Example

| | | | | | | | |
|---|---|---|---|---|---|---|---|
| 1.1 | 1.2 | | 1.4 | | 1.6 | | 1.8 |
| CC | CC | 13 | CC | 1.5 | CC | 1.7 | CC |

23° C.

| | | | | | | | | | |
|---|---|---|---|---|---|---|---|---|---|
| Shore | | 70 | 72 | 72 | 73 | 75 | 70 | 72 | 69 |
| A | | | | | | | | | |
| Hard- | | | | | | | | | |
| ness | | | | | | | | | |
| σ₁₀ | [MPa] | 0.7 | 0.8 | 0.8 | 0.8 | 0.9 | 0.7 | 0.8 | 0.7 |
| σ₂₅ | [MPa] | 1.3 | 1.5 | 1.5 | 1.6 | 1.8 | 1.4 | 1.5 | 1.3 |
| σ₅₀ | [MPa] | 2.5 | 2.9 | 3.1 | 3.4 | 4.2 | 2.5 | 3.1 | 2.4 |
| σ₁₀₀ | [MPa] | 7.1 | 9 | 9.3 | 10.7 | 11.8 | 7.3 | 8.9 | 7 |
| ε_{b} | [%] | 211 | 209 | 192 | 168 | 136 | 234 | 188 | 240 |
| TS | [MPa] | 21 | 22.6 | 20.4 | 17.6 | 16.7 | 23.7 | 20.2 | 25.6 |

70° C.

| | | | | | | | | | |
|---|---|---|---|---|---|---|---|---|---|
| Shore | | 69 | 70 | 71 | — | — | — | 70 | 69 |
| A | | | | | | | | | |
| hard- | | | | | | | | | |
| ness | | | | | | | | | |
| σ₁₀ | [MPa] | 0.6 | 0.7 | 0.7 | 0.7 | 0.7 | 0.6 | 0.7 | 0.6 |
| σ₂₅ | [MPa] | 1.2 | 1.4 | 1.4 | 1.5 | 1.6 | 1.2 | 1.4 | 1.2 |
| σ₅₀ | [MPa] | 2.2 | 2.7 | 2.9 | 3 | 3.6 | 2.3 | 2.7 | 2.2 |
| σ₁₀₀ | [MPa] | 6.2 | 8 | 8.3 | 9.3 | — | 6.5 | 7.6 | 6.1 |
| ε_{b} | [%] | 163 | 143 | 124 | 103 | 97 | 148 | 136 | 164 |
| TS | [MPa] | 13.7 | 13.3 | 11.4 | 9.7 | 9.6 | 12 | 11.6 | 14 |

Inventive Examples 1.3, 1.5 and 1.7, compared to the noninventive examples, both at 23° C. and at 70° C., have an equally good or even higher level of stress values at 50% and 100% strain. This means that the degree of crosslinking of the inventive examples is equal or higher and hence the elastic properties are improved.

### (D2) Determination of Compression Set to DIN ISO 815

The compression set of the vulcanizates was determined to DIN ISO 815. For this purpose, the vulcanizates (test specimens A) were compressed by 25% and stored in the compressed state at different temperatures (−30° C. and 150° C.) for different times (70 h and 158 h) (Table 6). After these storage times, the samples were released and the permanent deformation was determined at 23° C. As shown in Table 6, vulcanizates 1.3 and 1.7 produced in accordance with the invention have, both after storage at −30° C./70 h and after storage at 150° C./168 h, lower (i.e. better) values for the compression set than the corresponding noninventive examples. The lower compression set after storage at −30° C./70 h means that the low-temperature properties of the vulcanizate are improved. The lower compression set after storage at 150° C./168 h means that the ageing properties of the vulcanizate are additionally improved. On the basis of the improved compression sets, it can be stated that the vulcanizates 1.3 and 1.7 produced in accordance with the invention have improved properties both at low and at high temperatures. The reduced compression sets are an indication that vulcanizates based on the blends produced in accordance with the invention have improved properties at high and low temperatures.

TABLE 6
Compression set of the vulcanized rubber mixtures

| | | Example | | | | | | | |
|---|---|---|---|---|---|---|---|---|---|
| | | 1.1 | 1.2 | | 1.4 | | 1.6 | | 1.8 |
| | | CC | CC | 13 | CC | 1.5 | CC | 1.7 | CC |
| −30° C./70 h | % | 102 | 100 | 93 | — | — | — | 97 | 97 |
| 150° C./168 h | % | 40 | 35 | 31 | — | — | — | 38 | 43 |

### (D3) Determination of Thermal Retraction (TR)

To characterize the elasticity at low temperatures, the thermal retraction (TR) was determined to ISO 2921. For this purpose, the vulcanizates were elongated by 50% and frozen in a silicone oil bath cooled to −70° C. After the sample had been released, the bath was heated at 1° C./min and the percentage retraction of the sample was determined as a function of temperature. The temperatures were determined in each case at which the vulcanizates had retracted by 10% (TR10), 50% (TR50) and 70% (TR70); the lower the corresponding temperature, the better the vulcanizate. As can be seen in Table 7, the retraction of the vulcanizates based on the HNBR/VMQ blends produced in accordance with the invention, 1.3, 1.5 and 1.7, is attained at lower temperatures than in the case of the corresponding vulcanizates of the noninventive examples, i.e. the low-temperature flexibility of the examples produced in accordance with the invention is improved.

TABLE 7
Low-temperature retraction of the vulcanized rubber mixtures

| | Example | | | | | | | |
|---|---|---|---|---|---|---|---|---|
| | 1.1 | 1.2 | | 1.4 | | 1.6 | | 1.8 |
| | CC | CC | 13 | CC | 1.5 | CC | 1.7 | CC |
| TR10 (° C.) | −23.9 | −24.7 | −25.5 | −27.7 | −27.8 | −24.1 | −27 | −24 |
| TR50 (° C.) | −16.4 | −17.4 | −18.0 | −18.7 | −19.7 | −16.5 | −19 | −17 |
| TR70 (° C.) | −12.6 | −13.7 | −14.8 | −14.5 | −15.8 | −12.9 | −15 | −14 |

The examples show that the addition of a metathesis catalyst in the course of production of HNBR/VMQ blends gives an unexpectedly good distribution of VMQ in the HNBR phase. The HNBR/VMQ blends produced with addition of the metathesis catalyst have a bimodal molar mass distribution which, compared to the noninventive HNBR/VMQ blends, additionally have a high molecular weight peak (graft copolymer). Vulcanizates based on the HNBR/VMQ blends produced in accordance with the invention additionally have equally good or improved mechanical properties, and also improved properties at low and high temperatures.

What is claimed is:

1. Process for producing a rubber blend by mixing at least one partly hydrogenated nitrile rubber and at least one silicone rubber containing vinyl groups with one another, characterized in that the mixing is effected in the presence of a metathesis catalyst which is a complex catalyst which is based on a metal of transition group 6 or 8 of the Periodic Table and has at least one ligand bound in a carbene-like manner to the metal.

2. Process according to claim 1, characterized in that the process is effected essentially without organic solvents, preferably with an amount of organic solvent of not more than 1200 ppm, more preferably not more than 500 ppm and especially not more than 100 ppm.

3. Process according to claim 1 or 2, characterized in that a partly hydrogenated nitrile rubber containing repeat units which derive from at least one conjugated diene and at least one α,β-unsaturated nitrile is used, where the C═C double bonds from the polymerized diene monomers have been partly hydrogenated, preferably to an extent of at least 50% up to a maximum of 99%, more preferably to an extent of 75 to 98.5%, even more preferably to an extent of 80 to 98% and especially to an extent of 85 to 96%, and in that an organopolysiloxane containing vinyl groups and containing two or more types of repeat units of the general formula (I) is used 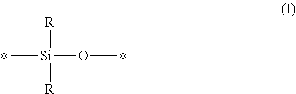
in which
R are the same or different and are each a substituted or unsubstituted monovalent hydrocarbyl radical having 1 to 6 carbon atoms,
where the organopolysiloxane has a total of 1 to 20 000 repeat units, preferably 50 to 15 000 and more preferably 200 to 10 000 repeat units, and one type of repeat units of the general formula (I) in which at least one of the R radicals contains one or more C═C double bonds is present.

4. Process according to claim 1 or 2, characterized in that at least one acrylonitrile-butadiene copolymer in which 75 to 98.5%, even more preferably 80 to 98% and especially 85 to 96% of the C═C double bonds have been hydrogenated, and at least one silicone rubber containing vinyl groups and selected from the group consisting of VMQ (vinylmethylsilicone rubber), PVMQ (phenyl vinylmethylsilicone rubber) and FVMQ (3,3,3-trifluoropropylvinylmethylsilicone rubber) is used.

5. Process according to claim 1 or 2, characterized in that a metathesis catalyst of the general formula (A) is used 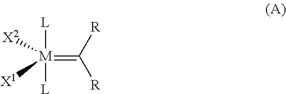
in which
M is osmium or ruthenium,
X¹, X² are the same or different and are two ligands, preferably anionic ligands,
L are identical or different ligands, preferably uncharged electron donors, and
R are the same or different and are each hydrogen, alkyl, preferably C₁-C₃₀-alkyl, cycloalkyl, preferably C₃-C₂₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where all these radicals may each optionally be substituted by one or more alkyl, halogen, alkoxy, aryl or heteroaryl radicals, or alternatively both R radicals together with the common carbon atom to which they are bonded are bridged to form a cyclic group which may be aliphatic or aromatic in nature, is optionally substituted and may contain one or more heteroatoms.

6. Process according to claim 5, characterized in that the metathesis catalysts used are those having the structures (IV) (Grubbs (I) catalyst) and (V) (Grubbs (II) catalyst), where Cy is cyclohexyl.

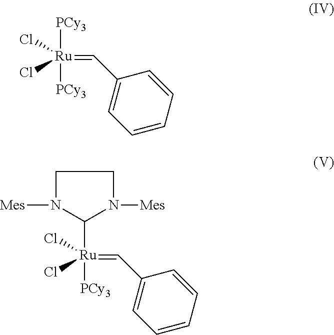

7. Process according to claim 1 or 2, characterized in that a metathesis catalyst of the general formula (B) is used 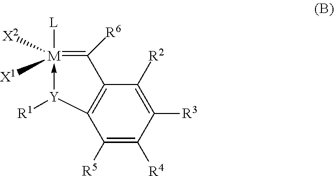
in which
M is ruthenium or osmium,
X¹ and X² are identical or different ligands, preferably anionic ligands,
Y is oxygen (O), sulphur (S), an N—R¹ radical or a P—R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
R², R³, R⁴, R⁵ are the same or different and are each hydrogen or organic or inorganic radicals,
R⁶ is H or an alkyl, alkenyl, alkynyl or aryl radical and
L is a ligand as defined for the formula (A).

8. Process according to claim 1 or 2, characterized in that a metathesis catalyst of the formula (VII) or of the formula (XVI) where Mes in each case is 2,4,6-trimethylphenyl is used.

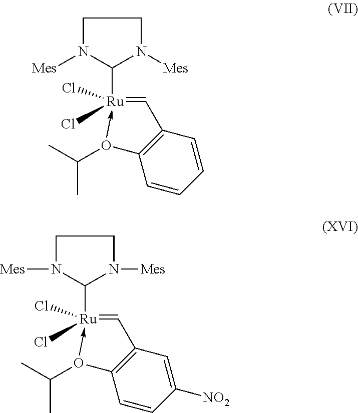

9. Rubber blend based on at least one partly hydrogenated nitrile rubber and at least one silicone rubber containing vinyl groups, obtainable by the process according to claim 1 or 2.

10. Vulcanizable mixtures comprising a rubber blend according to claim 9 and at least one peroxidic crosslinking system.

11. Vulcanizable mixtures according to claim 10, characterized in that the peroxidic crosslinking system used is bis(2,4-dichlorobenzyl)peroxide, dibenzoyl peroxide, bis(4-chlorobenzoyl)peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide or 2,5-dimethyl-2,5-di(t-butylperoxy)-3-hexyne.

12. Process for producing vulcanizates by subjecting a vulcanizable mixture according to claim 10 to a crosslinking reaction by increasing the temperature.

13. Vulcanizates based on at least one partly hydrogenated nitrile rubber and at least one silicone rubber containing vinyl groups, obtainable by the process according to claim 12.
